(19) United States
(12) Patent Application Publication
(10) Pub. No.: US 2001/0026545 A1
(43) Pub. Date: Oct. 4, 2001

(54) Method and apparatus for registering IP terminal device in line-switching exchanger

(75) Inventors: Takashi Matsumoto, Kawasaki (JP); Hiroshi Ozawa, Shinjuku (JP); Kazushige Haruta, Kawasaki (JP)

Correspondence Address: HELFGOTT & KARAS, P.C., 60th FLOOR, EMPIRE STATE BUILDING, NEW YORK, NY, 10118, US

(73) Assignee: FUJITSU LIMITED

(21) Appl. No.: 09/746,616

(22) Filed: Dec. 21, 2000

(30) Foreign Application Priority Data
Mar. 28, 2000 (JP) 2000-089830

(51) Int. Cl. H04Q 7/24

(52) U.S. Cl. 370/338; 370/401; 370/352; 370/349

(57) ABSTRACT

A method of registering an IP (Internet Protocol) terminal device including a function to transmit and receive IP packets, to a line-switching exchanger including a database that is used for managing a type and a telephone number of a telephone set is provided. The method includes the steps of connecting the line-switching exchanger and a network-gateway device by use of a radio-base-station-connection line that is used for connecting radio base stations, connecting the network-gateway device and the IP terminal device through an IP network, and registering the IP terminal device as a radiotelephony device in the database. By registering the IP terminal device as a radiotelephony device in the database provided in the line-switching exchanger, the IP terminal device can receive a variety of supplementary services provided by the line-switching exchanger since the IP terminal device is defined as a radiotelephony device, for example, a PHS phone, by the line-switching exchanger. Additionally, data for each of IP terminal devices on an IP network stored in the database of the line-switching exchanger does not need to be updated when the IP terminal device is moved from one location to another location on the IP network since location information of the IP terminal device is initially registered in the database of the line-switching exchanger based on location-registration information of the IP terminal device.

### BACKGROUND OF THE INVENTION

1. Field of the Invention

The present invention relates to a method and an apparatus for registering an IP (Internet Protocol) terminal device in an IP network system, and more particularly relates to a method of registering a VoIP (Voice over IP) terminal device that transmits a voice signal by use of IP packets on an IP network to a PBX (Private Branch exchange), and apparatuses such as a network-gateway device, a network-gatekeeper device and an IP terminal device used for the method of registering the VoIP terminal device.

2. Description of the Related Art

With recent and rapid development of IP networks, many business enterprises have been moving forward to improve an information infrastructure by creating a company-wide Intranet and by utilizing various applications such as e-mail and Web access. In such a movement, use of multimedia communication is found in an increasing number of areas, the multimedia communication utilizing newly available functions such as e-mail in addition to existing telephone and facsimile functions.

In general, as shown in FIG. 1A, an IP network 11 is separately established as an independent network from an audio-system network 10, which deals with line-switch-based communications such as telephone calls and facsimile connections. Because of recent practical application of VoIP (Voice over IP) technology that transmits telephone and facsimile signals through IP networks by converting the signals into IP packets, there has been an attempt to integrate communication traffic of telephone and facsimile calls into a voice-signal-integrated IP network 12, as shown in FIG. 1B. Such integration reduces overall costs, compared to the case in which the audio-system network 10 and the IP network 11 are established, controlled, and managed separately. Prospect of such an integrated system gives rise to expectations for convenient use of various services since signals relating telephone and facsimile calls are now treated as IP packets. This expectation will facilitate the movement toward the integration.

A conventional audio-system network used within companies has been developed based on use of a PBX (Private Branch exchange) system, which is a line-switching exchanger. In the conventional audio-system network, an extension number is assigned to each of telephone sets and facsimile devices connected to the PBX. A user calls a telephone set or a facsimile device by specifying its extension number. Because of movement toward the integration, the number of telephone sets and facsimile devices used in IP networks is expected to increase steadily. In such an integrated system, it will become necessary to call from a telephone set connected to a PBX to another telephone set connected to an IP network and also to call in the opposite direction.

FIG. 2 is a block diagram showing a connection between the PBX and the voice-signal-integrated IP network 12. The audio-system network 10 includes a PBX 13, a telephone set or a facsimile device having an extension number 2000, and a telephone set or a facsimile device having an extension number 2001. The voice-signal-integrated IP network 12 includes a telephone set 14 having an extension number 3000 and a facsimile device 15 having an extension number 3001. As shown in FIG. 2, telephone sets connected to the PBX 13 are usually connected with the telephone set 14 and the facsimile device 15 on the voice-signal-integrated IP network 12 through a network-gateway device 16. In the above-described case, a user of a telephone set or a facsimile device connected to the PBX 13 needs to know address information to specify the telephone set 14 and the facsimile device 15 on the voice-signal-integrated IP network 12. Additionally, a user of the telephone set 14 or the facsimile device 15 on the voice-signal-integrated IP network 12 needs to know address information to specify a telephone set and a facsimile device connected to the PBX 13. Such address information is preferred to be extension numbers so that a user does not have to consider whether a location of a telephone set or a facsimile device on a receiving end is connected to the PBX 13 or to the voice-signal-integrated IP network 12.

In other words, each of the telephone set 14 and the facsimile device 15 that are connected to the voice-signal-integrated IP network 12 is provided with an extension number used for the PBX 13 so that a user can make a call or transmit a document without being aware of the PBX 13 and the voice-signal-integrated IP network 12. Accordingly, a user can use the telephone set 14 and the facsimile device 15 connected to the voice-signal-integrated IP network 12 as if the telephone set 14 and the facsimile device 15 were extension terminals of the PBX 13. In a conventional IP network, the network-gateway device 16 is connected to a BRI (Basic Rate Interface) private line or a PRI (Primary Rate Interface) private line of the PBX 13. Interfaces such as a BRI and a PRI provided by a PBX are designed to have the same specifications as those provided by a public ISDN (Integrated Services Digital Network) such as “INS net 64/1500” provided by NTT. Thus, the network-gateway device 16 can be connected to the BRI private line and the PRI private line of the PBX 13 as well as BRI and PRI subscriber lines of the public ISDN.

FIG. 3 is a block diagram showing a conventional IP network system. The conventional IP network system shown in FIG. 3 includes a PBX 13, a network-gateway device 16, a LAN (Local Area Network) 17, a network-gatekeeper device 18, and telephone sets having extension numbers 2000, 3001, and 3002 respectively. In FIG. 3, the network-gateway device 16 includes a line-connecting interface for a BRI connected to a BRI private line or a PRI connected to a PRI private line, and a LAN interface connected to the LAN 17, which is an IP network. The network-gatekeeper device 18 converts a telephone number to an IP address, and manages telephone sets provided on the LAN 17. The network-gatekeeper device 18 deals with a RAS (Registration Admissions and Status) procedure defined by the ITUT H.323, and thus, each telephone set on the LAN 17 and the network-gateway device 16 can exchange a variety of information with the network-gatekeeper device 18 by use of RAS messages regulated by the ITU-T H.323.

For instance, when a user calls from the telephone set having an extension number 3001 to the telephone set having an extension number 3002, the telephone set having the extension number 3001 initially sends an inquiry to the network-gatekeeper device 18 about an IP address of the telephone set having the extension number 3002 by using a RAS message. After having received the IP address of the telephone set having the extension number 3002 from the network-gatekeeper device 18, the telephone set having the extension number 3001 sets up a VoIP call to the received IP address.

FIG. 4 is a block diagram showing signal flow in a case in which a user calls from the telephone set having the extension number 3001 to the telephone set having the extension number 2000 in the conventional IP network system. Each unit with a number in FIG. 4 corresponds to a unit with the same number in FIG. 3. Initially, at a step S1, the telephone set having the extension number 3001 sends an inquiry to the network-gatekeeper device 18 about the IP address of the telephone set having the extension number 2000. At a step S2, the network-gatekeeper device 18 returns the IP address of the network-gateway device 16 to the telephone set having the extension number 3001. Subsequently, at a step S3, the telephone set having the extension number 3001 sets up a VoIP call to the IP address of the network-gateway device 16. The network-gateway device 16 then executes settings for a line-switching call to the extension number 2000 by use of an interface for the BRI or the PRI at a step S4. At a step S5, the PBX 13 calls the telephone set having the extension number 2000. After the telephone set having the extension number 2000 has responded to the call made by the PBX 13, a communication line between the telephone set having the extension number 3001 and the telephone set having the extension number 2000 is established via the network-gateway device 16 at a step S6. When the communication line is in service, the network-gateway device 16 exchanges IP packets including voice signals and voice information between the telephone set having the extension number 3001 and the telephone set having the extension number 2000.

On the other hand, FIG. 5 is a block diagram showing signal flow in a case in which a user calls from the telephone set having the extension number 2000 to the telephone set having the extension number 3001 in the conventional IP network system. Each unit with a number in FIG. 5 corresponds to a unit with the same number in FIG. 3. In the case shown in FIG. 5, an inward-dialing function of the PBX 13 is utilized in calling from the telephone set having the extension number 2000 to the telephone set having the extension number 3001. In general, a single extension number is assigned to each ISDN interface. On the other hand, the inward-dialing function of the PBX 13 virtually assigns a plurality of extension numbers to the interface, and notifies the interface about an extension number to which a call has been made when the interface receives the call.

In FIG. 5, the extension number of the BRI or the PRI interface to which the network-gateway device 16 is connected, is 3000. However, the extension numbers 3001 and 3002 are assigned as inward-dialing numbers corresponding to the interface having the extension number 3000. In a case in which the telephone set having its extension number 2000 has called the extension number 3001, the PBX 13 calls the interface having the extension number 3000. Since a call message received by the interface includes information indicating that the destination extension number is 3001, the network-gateway device 16 can recognizes that a call destination is the telephone set having the extension number 3001.

A signal flow in the system will be described below. At a step S11, the telephone set having the extension number 2000 sets up a call to the extension number 3001 by use of the line switching. At a step S12, the PBX 13 checks whether the extension number 3001 is an inward-dialing number. As a result, the PBX 13 detects the extension number 3001 as the inward-dialing number to the extension number 3000 as shown in FIG. 5. Subsequently, at a step S13, the PBX 13 executes an inward dialing to the extension number 3000 for calling the destination extension number 3001. The network-gateway device 16 sends an inquiry to the network-gatekeeper device 18 about the IP address corresponding to the extension number 3001 at a step S14. In response to the inquiry made by the network-gateway device 16, the network-gatekeeper device 18 returns the IP address corresponding to the extension number 3001 to the network-gateway device 16 at a step S15. Then, at a step S16, the network-gateway device 16 sets up a call to the IP address of the extension number 3001 by use of the VoIP. After the telephone set having the extension number 3001 has responded to the call setting made by the network-gateway device 16, a line between the telephone set having the extension number 2000 and the telephone set having the extension number 3001 is established via the network-gateway device 16 at a step S17. When the line is in service, the network-gateway device 16 exchanges IP packets including voice signals and voice information between the telephone set having the extension number 2000 and the telephone set having the extension number 3001.

As described above, the conventional network-gateway device 16 connected to the BRI or the PRI of the PBX 13 can also be connected to the BRI and PRI subscriber lines of the public ISDN, and thus has high versatility. Accordingly, the production cost of the device 16 is low. However, the conventional network-gateway device 16 has the following problems. First, the network-gateway device 16 connected to the BRI or the PRI of the PBX 13 cannot receive a variety of supplementary services of the PBX 13. Second, the extension number of a telephone set must be registered both in the PBX 13 and the network-gatekeeper device 18. Finally, in a case that a telephone set connected to an IP network (the voice-signal-integrated IP network 12) is moved to other locations, data related to the telephone set stored in the PBX 13 must be updated.

A PBX provides a variety of supplementary services such as call forwarding, telephone conferencing, call picking-up, absence forwarding, and voice mail. These services have been developed for analog telephone sets and private digital telephone sets so that telephone sets and other devices connected to private analog lines and private digital lines of the PBX can receive almost all the supplementary services. However, a method of controlling supplementary services for the ISDN is different from that for regular private analog and digital lines, and devices connected to the ISDN can only receive services standardized by such as the ITU-T. A manufacturer of such devices can provide additional services to the devices by adding the manufacturer's original messages to a call message transmitted to interfaces of the ISDN. However, the devices will loose their advantage of using the ISDN, that is, the advantage to be able to add devices produced by any manufacturer to the ISDN since specifications of the interfaces of the ISDN are standardized.

As described above, a user of a telephone set can communicate with other telephone sets without being aware of whether the telephone sets are connected to the PBX or are connected to the IP network, by providing an extension number used for the PBX to each telephone set placed on the IP network, and then by connecting the telephone set on the IP network and a telephone set connected to the PBX through a network-gateway device by use of their extension numbers. However, in a case that services provided for telephone sets connected to the ISDN and telephone sets connected to the regular private analog and digital lines are different from each other, a user of a telephone set using supplementary services must be aware of a location of the other party's telephone set.

Consequently, in conventional methods of connecting a telephone set on an IP network to a PBX through a network-gateway device, a telephone set placed on the IP network cannot receive a variety of supplementary services of the PBX. Because of that, a user of a telephone set must be aware of whether each telephone set is connected to the PBX or to the IP network.

In the RAS procedure defined by the ITU-T H.323, a telephone set placed on an IP network automatically executes the following processes when the telephone set is powered on. The telephone set initially searches for a network-gatekeeper device after it has been powered on. If the network-gatekeeper device has been located, the telephone set registers its IP address and alias address such as a telephone number to the network-gatekeeper device.

Each terminal device on the IP network is distinguished from others by its IP address. However, calling a telephone set on the IP network by use of its IP address is impractical. In addition, the IP address of the telephone set changes when the telephone set is moved to another network segment. The above-described problem can be solved by a method of registering an alias address such as a telephone number or an email address of each telephone set other than the IP address in the network-gatekeeper device, and converting the alias address of a destination telephone set to the IP address by use of the network-gatekeeper device. Thus, a call can be made from a telephone set to the destination telephone set by use of the alias address.

The above-described method of using the alias addresses for making calls is useful. However, the alias addresses reported to the network-gatekeeper device by each telephone set are not necessarily correct. For instance, an extension number for the PBX is used as an alias address of each telephone set in the previously described conventional IP network system. Since extension numbers in many business enterprises are assigned to telephone sets intentionally, there is a demand for checking whether an extension number reported by a telephone set to a network-gatekeeper device is correct. In order to justify the extension number reported by the telephone set, the network-gatekeeper device usually stores information about a correct combination of an IP address and its corresponding extension number for each telephone set placed on the IP network. Subsequently, after receiving a request for registering a telephone set to the network-gatekeeper device from the telephone set, the network-gatekeeper device checks whether the combination of the IP address and the extension number received from the telephone set is correct by comparing the received combination with the correct combination of the IP address and the corresponding extension number stored in the network-gatekeeper device.

FIG. 6 is a diagram showing signal flow when adding a telephone set on the LAN 17 of the conventional IP network system. At a step S21 in FIG. 6, a telephone set on the LAN 17, for example, the telephone set having the extension number 3001 searches for the network-gatekeeper device 18, and transmits its IP address and extension number to the device 18 when the device 18 is located on the LAN 17. At a step S22, the network-gatekeeper device 18 checks whether the combination of the IP address and the extension number received from the telephone set is correct by comparing the received combination with the correct combination of the IP address and the corresponding extension number stored therein. At a step S23, the network-gatekeeper device 18 returns the result of the step S22 to the telephone set having the extension number 3001. When each telephone set on the IP network is assigned an extension number for the PBX 13, data stored in the PBX 13 and in the network-gatekeeper device 18 must be updated, and thus management of the PBX 13 and the network-gatekeeper device 18 becomes more complicated.

In an office, telephone sets are often moved from one location to another as a personnel is moved. In such case, there is a demand for using the same extension number after moving a telephone set. In order to keep the same extension number of a telephone set connected to the IP network even if the telephone set is moved to another network segment, it is necessary to change the IP address of the telephone set, and to register the telephone set again in the network-gatekeeper device. However, the change of the IP address can be automated by use of a DHCP (Dynamic Host Configuration Protocol) that provides an IP address dynamically to each telephone set on the IP network. Additionally, the registration of the telephone set is executed automatically by the DHCP following the above-described method with reference to FIG. 6. Accordingly, a user of the telephone set only needs to connect the telephone set to the network segment without updating any settings. It should be noted that settings of the network-gatekeeper device must be changed when checking whether a combination of the extension number and the IP address of the telephone set is correct.

However, when a plurality of network-gateway devices is connected to the PBX, it is necessary to update data stored in the PBX. FIG. 7 is a block diagram showing the PBX to which a plurality of network-gateway devices is connected. As shown in FIG. 7, network-gateway devices 16A and 16B are connected to the PBX 13. A router 19A is connected to a network segment 1 and a router 19B. Additionally, the router 19B is connected to a network segment 2. A black arrow in FIG. 7 indicates that the telephone set having the extension number 3001 is moved from the network segment 1 to the network segment 2. Before being moved to the network segment 2, the telephone set having the extension number 3001 was connected to the network segment 1, and thus the extension number 3001 is still registered as an inward-dialing number of the extension number 3000. If a user of the telephone set having the extension number 2000 calls the telephone having the extension number 3001, the PBX 13 calls a line having the extension number 3000 by use of the inward dialing. Consequently, a communication line A is established between the telephone set having the extension number 2000 and the telephone having the extension number 3001 through the routers 19A and 19B. Unless the data stored in the PBX 13 is updated, the PBX 13 calls the line having the extension number 3000, and the communication line A between the telephone set having the extension number 2000 and the telephone set having the extension number 3001 is established through the routers 19A and 19B. As seen from FIG. 7, communicating through the communication line A is inefficient. Additionally, the transmission speed of data through the communication line A is slow since the routers 19A and 19B are placed on the communication line A.

In order to establish a communication line more efficient than the communication line A, the data stored in the PBX 13 must be updated so that the extension number 3001 becomes an inward-dialing number of a line having an extension number 3100 shown in FIG. 7. Accordingly, when the telephone set having the extension number 2000 calls the telephone set having the extension number 3001, the PBX 13 calls the line having the extension number 3100 instead of the extension number 3000 by use of the inward dialing, thereby establishing the communication line B between the telephone having the extension number 2000 and the telephone having the extension number 3001. As described above, a communication path between two telephone sets can be optimized. However, when moving a telephone set from a network segment to another network segment in conventional IP network systems, it is necessary to update the data stored in the PBX 13, there by requiring cost to update the data.

### SUMMARY OF THE INVENTION

Accordingly, it is a general object of the present invention to provide a method of registering an IP terminal device to a line-switching exchanger. A more precise object of the present invention is to provide a method of registering an IP terminal device to a line-switching exchanger, wherein the IP terminal device can receive a variety of supplementary services provided by the line-switching exchanger, and data stored in the line-switching exchanger does not need to be updated when the IP terminal device connected to an IP network is moved from one location to another location on the IP network.

The above-described object of the present invention is achieved by a method of registering an IP (Internet Protocol) terminal device including a function to transmit and receive IP packets, to a line-switching exchanger including a database that is used for managing a type of a telephone set and its telephone number, the method including the steps of connecting the line-switching exchanger and a network-gateway device by use of a radio-base-station-connection line that is used for connecting radio base stations, connecting the network-gateway device and the IP terminal device through an IP network, and registering the IP terminal device as a radiotelephony device in the database.

By registering the IP terminal device as a radiotelephony device in the database provided in the line-switching exchanger, the IP terminal device can receive a variety of supplementary services provided by the line-switching exchanger since the IP terminal device is defined as a radiotelephony device, for example, a PHS phone, by the line-switching exchanger. Additionally, data for each of IP terminal devices on an IP network stored in the database of the line-switching exchanger does not need to be updated when the IP terminal device is moved from one location to another location on the IP network since location information of the IP terminal device is initially registered in the database of the line-switching exchanger based on location-registration information of the IP terminal device.

Other objects, features and advantages of the present invention will become more apparent from the following detailed description when read in conjunction with the accompanying drawings.

### BRIEF DESCRIPTION OF THE DRAWINGS

FIGS. 1A and 1B are block diagrams showing a voice-signal-integrated IP network;

FIG. 2 is a block diagram showing a connection between a PBX and the voice-signal-integrated IP network;

FIG. 3 is a block diagram showing a conventional IP network system wherein the PBX is provided;

FIG. 4 is a block diagram showing signal flow when a user calls from a telephone set having an extension number 3001 to a telephone set having an extension number 2000 in the conventional IP network system;

FIG. 5 is a block diagram showing signal flow when a user calls from the telephone set having the extension number 2000 to the telephone set having the extension number 3001 in the conventional IP network system;

FIG. 6 is a diagram showing signal flow when adding a telephone set on a LAN of the conventional IP network system;

FIG. 7 is a block diagram showing the PBX where a plurality of network-gateway devices is connected;

FIG. 8 is a block diagram for describing a call area and location registration of a PHS phone in a centralized PHS system;

FIG. 9 is a block diagram showing an authentication system provided in the centralized PHS system;

FIG. 10 is a block diagram showing a procedure to register a location of a terminal device, that is, the IP phone 50 according to a first embodiment of the present invention;

FIG. 11 is a block diagram showing a procedure to authenticate the IP phone according to a second embodiment of the present invention;

FIG. 12 is a block diagram showing a sequence of processes executed in an IP-terminal-device-registration system when the IP phone is turned on, according to a third embodiment of the present invention;

FIG. 13 is a block diagram showing a sequence of processes executed in the IP-terminal-device-registration system when the IP phone transmits a call, according to a fourth embodiment of the present invention;

FIG. 14 is a block diagram showing a sequence of processes executed in the IP-terminal-device-registration system when the IP phone receives a call, according to a fifth embodiment of the present invention;

FIG. 15 is a block diagram showing a sequence of processes taken by the devices according to the present invention when the IP phone is moved to another call area, according to a sixth embodiment of the present invention;

FIG. 16 is a block diagram showing a procedure to start up a call-switching service provided by the PBX by use of the network-gateway device according to a seventh embodiment of the present invention;

FIG. 17 is a block diagram showing a sequence of processes executed in the IP-terminal-device-registration system when a general IP phone is turned on, according to an eighth embodiment of the present invention;

FIG. 18 is a block diagram showing a sequence of processes executed in the IP-terminal-device-registration system when the general IP phone transmits a call, according to a ninth embodiment of the present invention;

FIG. 19 is a block diagram for describing a roaming function provided by the centralized PHS system; and

FIG. 20 is a block diagram for describing a combination of the roaming function provided by the centralized PHS system and the present invention, according to a tenth embodiment.

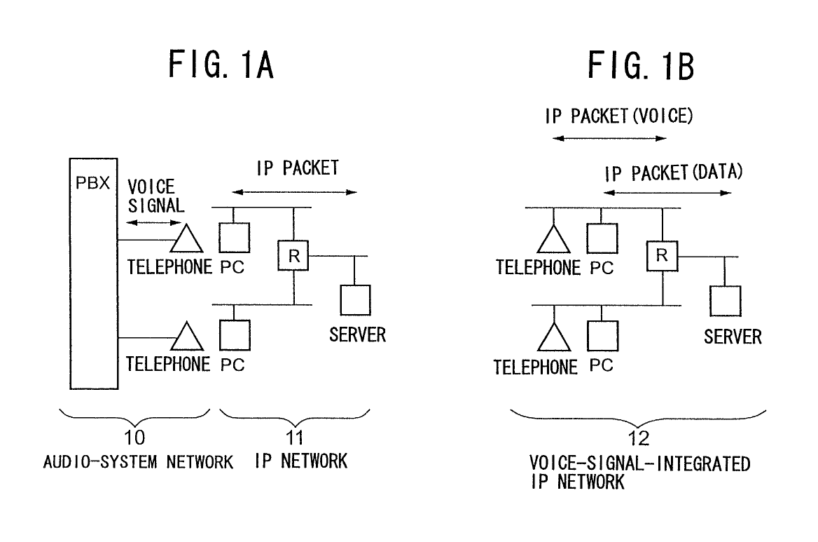

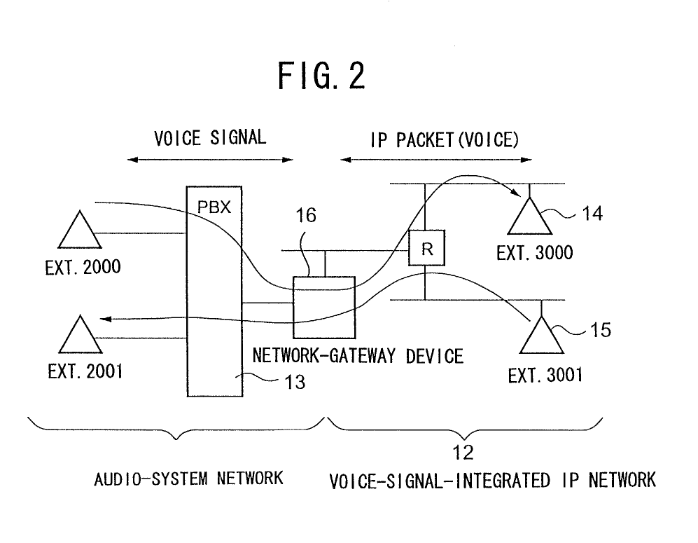

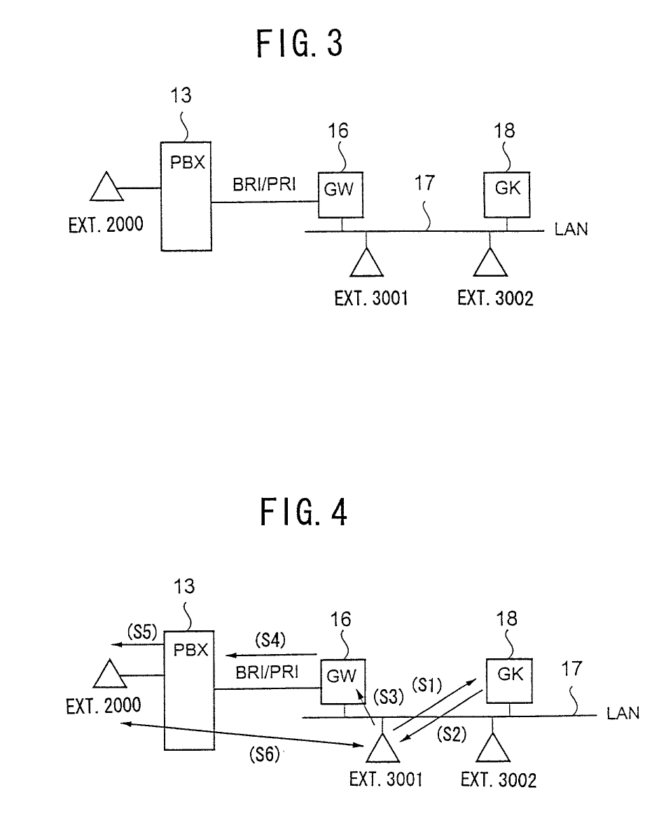

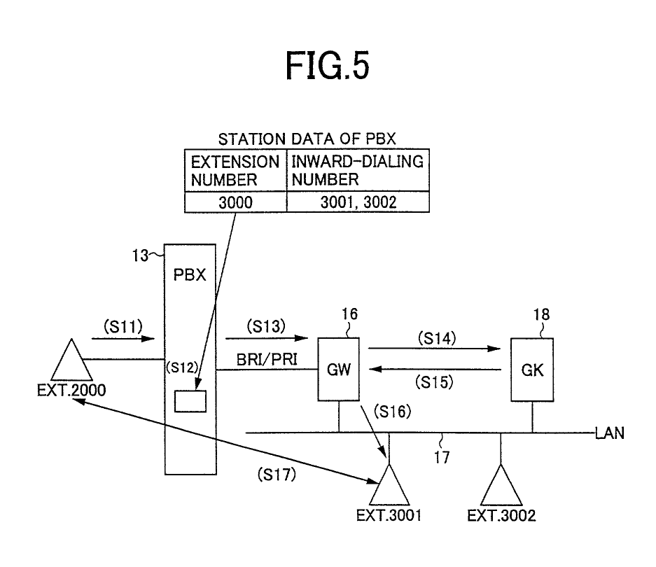

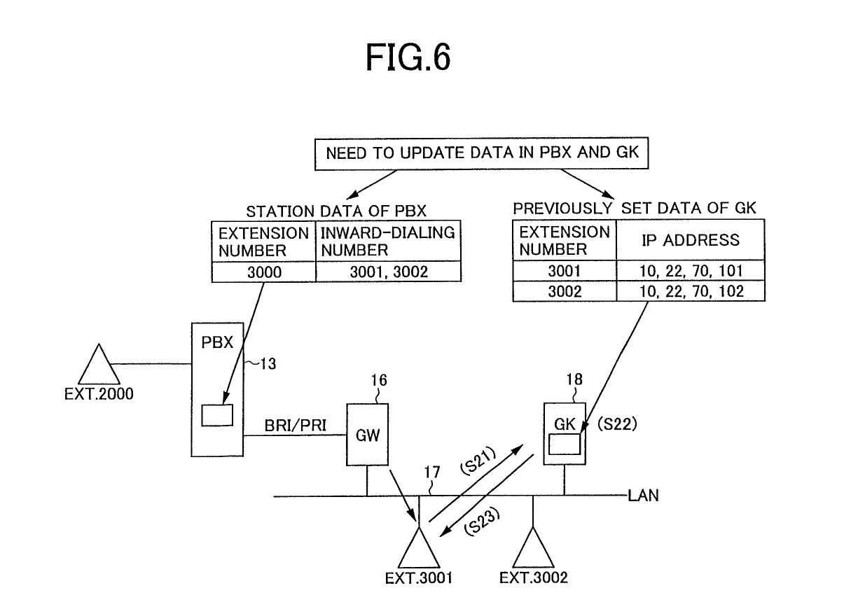

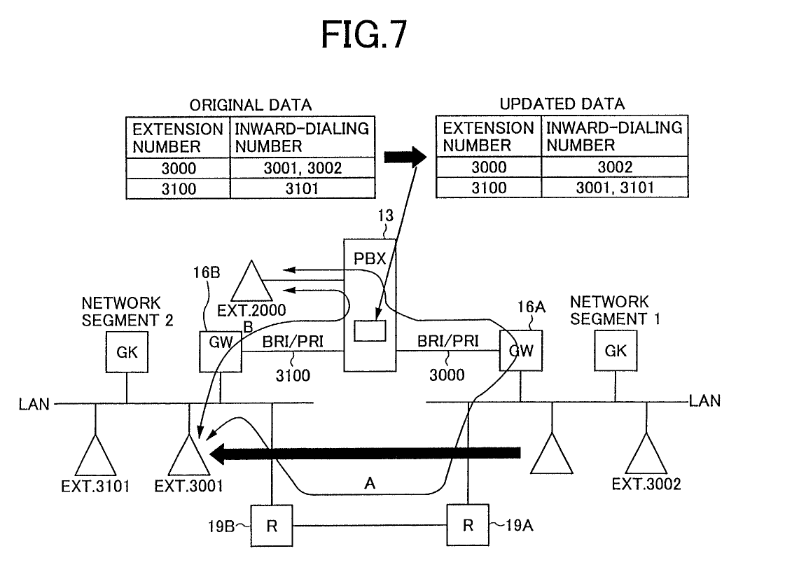

### DESCRIPTION OF THE PREFERRED EMBODIMENTS

A description will now be given of preferred embodiments of the present invention with reference to the accompanying drawings. Since a function of a centralized PHS system provided by a PBX is applied to the present invention, a description will be initially given of a summary of the centralized PHS system and the PBX. It should be noted that the centralized PHS system is an existing technology.

The PHS (Personal Handy-phone System) is a low-power radiotelephony system that uses radio waves having a frequency near 1.9 GHz. The PHS is used over a wide area of communication, for example, in public telecommunication services operated by common carriers. Additionally, a PHS phone is used as a cordless phone or a radiotelephony device in an office or at home. The centralized PHS system is a communication system wherein the PHS phone is used as a terminal device of the PBX (Private Branch exchange), and PHS base stations are connected to the PBX so that the PHS phone can be connected to any of the PHS base stations by radio communication. Accordingly, a user of the PHS phone can transmit or receive a call anywhere in the office.

PHS base stations, which are radio base stations, transmit call signals to a PHS phone in order to call the PHS phone. After receiving the call signals from the PHS base stations, the PHS phone responds to the call signal received from all PHS base stations by establishing a radio link to a PHS base station closest to the PHS phone. Since it is inefficient to transmit the call signals from all PHS base stations to the PHS phone, the PHS base stations are separated into groups, and transmit call signals as a group to the PHS phone. The PBX needs to manage a location of the PHS phone, and more precisely which call area the PHS phone is located in. It should be noted that the call area is a range reachable by radio waves transmitted from a PHS base station belonging to a group. Information about the call area wherein the PHS phone is located is managed by a function called a location registration. Each call area is provided with an area number. Each PHS base station periodically notifies the PHS phone about the area number of the call area wherein the PHS base station is placed. The PHS phone is controlled to communicate with the closest PHS base station, and thus a PHS base station that communicates with the PHS phone is switched each time the PHS phone is moved to another call area. However, the PHS phone can recognize a call area wherein the PHS phone is located by checking the area number of the call area when the PHS phone is moved to the call area. In a case that the call area for the PHS phone is changed, the PHS phone notifies the PBX about the change of the call area by transmitting a locationregistration signal to the PBX.

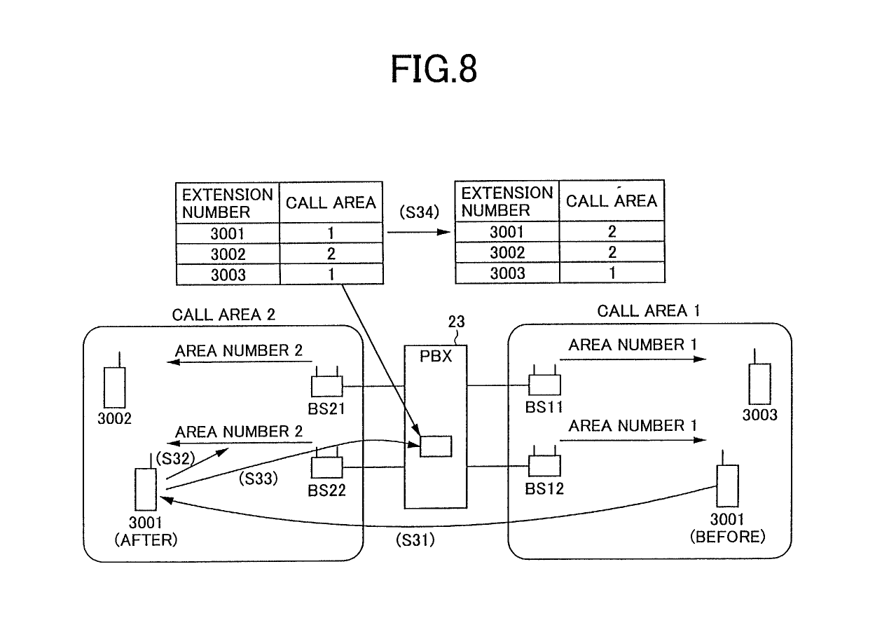

FIG. 8 is a block diagram for describing a call area and location registration of the PHS phone in the centralized PHS system. In FIG. 8, a call area 1 includes a PHS phone 3001 having an extension number 3001, a PHS phone 3003 having an extension number 3003, and PHS base stations BS11 and BS12. A call area 2 includes the PHS phone 3001 (after being moved), a PHS phone 3002 having an extension number 3002, and PHS base stations BS21 and BS22. The PHS base stations BS11, BS12, BS21 and BS22 are connected to a PBX 23. At a step S31, the PHS phone 3001 is moved from the call area 1 to the call area 2. The PHS phone 3001 then searches for the closest PHS base station BS22 in the call area 2, and checks the area number of the call area 2 at a step S32. Since the area number is changed from “1” to “2”, the PHS phone transmits a location-registration signal to the PBX 23 at a step S33. At a step S34, the PBX 23 updates the area number for the PHS phone 3001 from “1” to “2” after receiving the location-registration signal therefrom.

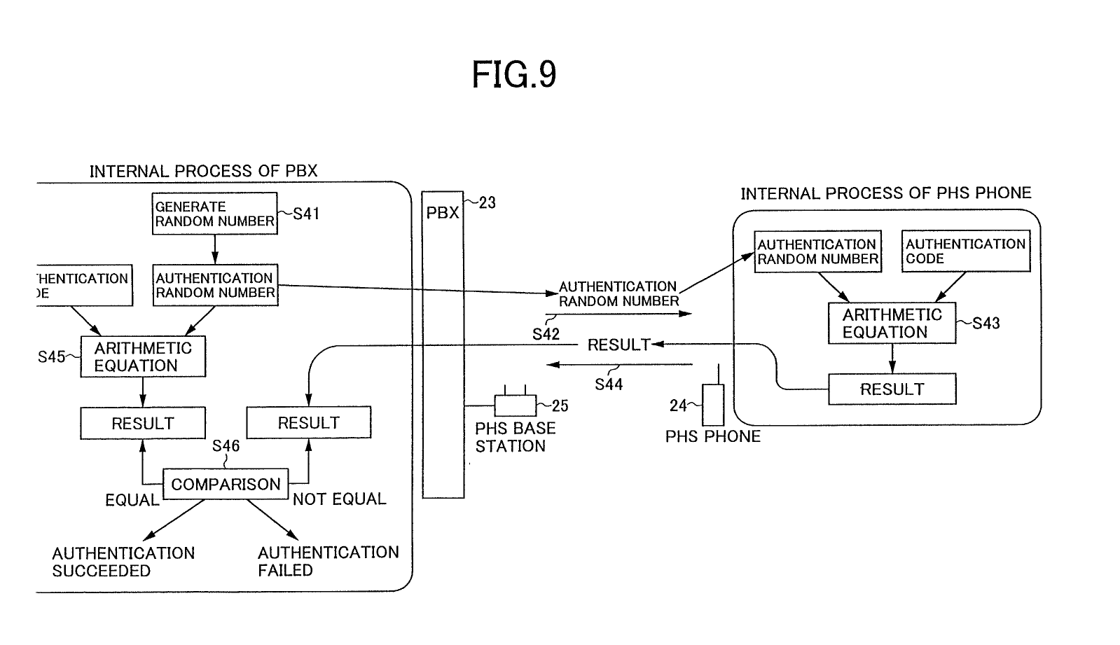

FIG. 9 is a block diagram showing an authentication system provided in the centralized PHS system. The PBX authenticates the PHS phone when the PHS phone transmits or receives a call for preventing unauthorized use of the PHS phone. Additionally, the PBX also authenticates the PHS phone when the PHS phone transmits a location-registration signal to the PBX for preventing unauthorized use of the PHS phone. FIG. 9 includes the PBX 23, a PHS phone 24, a PHS base station 25, and boxes showing an internal process of the PBX 23 and an internal process of the PHS phone 24.

Authentication codes are initially provided in the PBX 23 and the PHS phone 24. When the PHS phone 24 transmits or receives a call, and when the PBX 23 executes the location registration of the PHS phone 24, the PBX 23 generates a random number called an authentication random number at a step S41, and reports the number to the PHS phone 24 at a step S42. After receiving the authentication random number from the PBX 23 through the PHS base station 25, the PHS phone executes an arithmetic operation based on the authentication code stored therein and the received authentication random number by applying an arithmetic equation called an authentication algorithm at a step S43. The PHS phone then returns the result of the arithmetic operation to the PBX 23 through the PHS base station 25 at a step S44. Meanwhile, the PBX 23 also executes the arithmetic operation based on the authentication code stored therein and the generated authentication random number at a step S45. At a step S46, the PBX 23 decides whether the results of the arithmetic operations executed by the PHS phone 24 and the PBX 23 are the same. If it is ascertained at the step S46 that the results obtained by the PBX 23 and the PHS phone 24 are the same, the PBX 23 determines that the authentication of the PHS phone 24 is successful. If it is ascertained that the results obtained by the PBX 23 and the PHS phone 24 are not the same, the PBX 23 determines that the authentication of the PHS phone 24 has failed.

If the authentication of the PHS phone 24 is successful, the PBX 23 continues executing processes necessary for registering the location of the PHS phone 24, and for transmitting or receiving a call by the PHS phone 24. If the authentication of the PHS phone 24 has failed, the PBX 23 determines that the PHS phone 24 has been used without authorization, and thus terminates the processes necessary for registering the location of the PHS phone 24, and for transmitting or receiving the call by the PHS phone 24.

The PBX 23 provides a variety of supplementary services to private telephone sets connected thereto, and is designed for an analog telephone set to start up the services by use of a hooking signal and additional dial numbers. The centralized PHS system defines information for transmitting the hooking signal and the additional dial numbers in a control signal used among the PBX 23, the PHS phone 24 and the PHS base station 25, for the PHS phone 24 to receive a variety of the supplementary services. Accordingly, when a user of the PHS phone 24 executes a hooking operation or dials an additional dial number, the PHS phone 24 transmits the hooking signal or the additional dial number to the PBX 23. Therefore, the PHS phone 24 can receive supplementary services of the PBX 23 such as call switching. The above-described steps executed in the PBX 23 correspond to an IP-terminal-authentication unit in the claims.

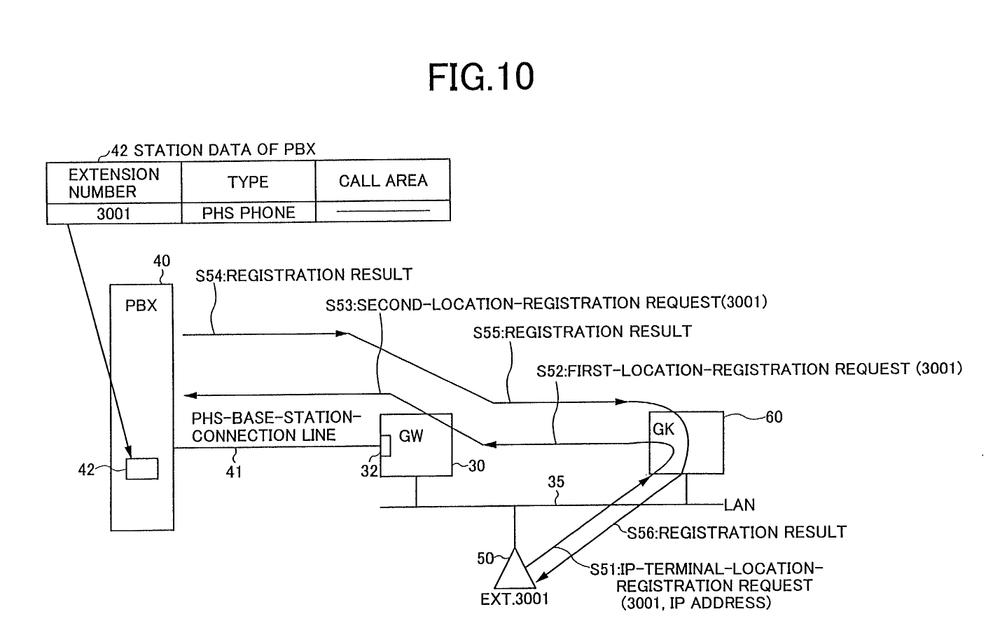

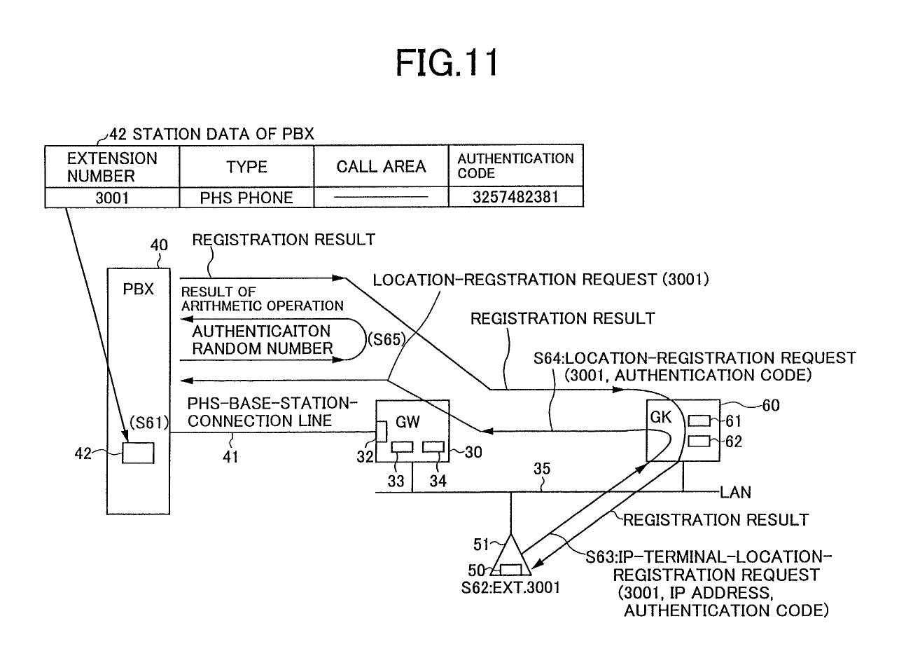

A description will now be given of a concept of the present invention with reference to FIGS. 10 and 11. FIG. 10 includes a network-gateway device 30, a PBX 40, an IP phone 50 (IP terminal device) having the extension number 3001, and a network-gatekeeper device 60. The network-gateway device 30, the IP phone 50 and the network-gatekeeper device 60 are connected to each other through a LAN 35. Additionally the PBX 40 includes station data 42 as a database wherein an extension number provided for each telephone set, such as the IP phone 50 on the LAN 35, is registered as an extension number for a PHS phone. In other words, the IP phone 50 is registered as a PHS phone in the PBX 40. The network-gateway device 30 includes a PHS-base-station-connection interface 32 to connect the network-gateway device 30 with the PBX 40 through a PHS-base-station-connection line 41, that is, a radio-base-station-connection line. The network-gateway device 30 exchanges a signal controlling transmission and reception of a call between the PBX 40 and the network-gateway device 30 on the PHS-base-station-connection line 41, and an IP packet that includes a signal controlling transmission and reception of the call between the IP phone 50 and the network-gateway device 30 on the LAN 35. Additionally, the network-gateway device 30 exchanges a voice signal transmitted and received between the PBX 40 and the network-gateway device 30 on the PHS-base-station-connection line 41, and an IP packet including an encoded voice signal that is transmitted and received between the network-gateway device 30 and the IP phone 50 on the LAN 35.

As described above, the PBX 40 and the IP phone 50 are connected physically through the network-gateway device 30, and thus a signal transmitted from the PBX 40 through the PHS-base-station connection line 41 is relayed by the network-gateway device 30, and is received by the IP phone 50.

Additionally, the station data 42 includes information about a call area, that is, location information indicating in which call area a telephone set is located if the telephone set is a PHS phone. Since the PBX 40 recognizes the IP phone as a PHS phone hypothetically, the PBX 40 records a call area to which the network-gateway device 30 belongs, as the call area for the IP phone 50, for a data area corresponding to the extension number 3001 of the IP phone 50 in the station data 42, when the PBX 40 receives the location-registration signal including the extension number 3001 of the IP phone 50 from the network-gateway device 30. Accordingly, the PBX 40 can specify a network-gateway device whereto a call signal is transmitted from the PBX 40 when the PBX 40 has received the call signal for the IP phone 50, and thus efficiency of transmitting the call signal from the PBX 40 to the IP phone 50 increases by executing the location registration of the IP phone 50 similarly to the location-registration of a PHS phone.

A description will now be given of a procedure to register a location of a terminal device, that is, the IP phone 50, according to a first embodiment of the present invention with reference to FIG. 10. At a step S51 shown in FIG. 10, the IP phone 50 requests the network-gatekeeper device 60 to register the IP phone 50 in the PBX 40 by transmitting an IP-terminal-location-registration-request message including its extension number and its IP address to the network-gatekeeper device 60. After receiving the IP-terminal-location-registration-request message from the IP phone 50, the network-gatekeeper device 60 transmits a first location-registration-request message including the extension number of the IP phone 50 to the network-gateway device 30 at a step S52. The network-gateway device 30 generates a second location-registration-request message including the extension number of the IP phone 50 according to a specification of the PHS-base-station-connection interface 32, and transmits the second location-registration-request message to the PBX 40 at a step S53.

The PBX 40, after receiving the second location-registration-request message from the network-gateway device 30, executes the location registration of the IP phone 50, which is a function of the centralized PHS system. Whether the IP phone is successfully registered in the PBX 40 or not, the PBX 40 transmits the result of the location registration indicating a success or a failure of the location registration of the IP phone 50 to the network-gateway device 30 at a step S54. After receiving the result of the location registration from the PBX 40, the network-gateway device 30 notifies the network-gatekeeper device 60 about the result of the location registration of the IP phone 50 by executing a second registration-result-notification process at a step S55. The network-gatekeeper device 60 receives the result of the location registration from the network-gateway device 30, and transmits the result to the IP phone 50 by executing a first registration-result-notification process at a step S56. As described above, since the IP phone 50 can be registered as a PHS phone in the PBX 40, the IP phone 50 can receive supplementary services provided by the PBX 40. Additionally, since the network-gatekeeper device 60 transmits the first location-registration-request message to the network-gateway device 30 after receiving the IP-terminal-location-registration-request message from the IP phone 50, and transmits the result of the location registration received from the network-gateway device 30 to the IP phone 50, location information such as the extension number of the IP phone 50 can be stored in the station data 42 of the PBX 40 based on location-registration information including the extension number and the IP address of the IP phone 50.

In the above-described first embodiment of the present invention, the step S51 shown in FIG. 10 is referred to as an IP-terminal-location-registration-request unit in the claims.

A description will now be given of a procedure to authenticate a terminal device, that is, the IP phone 50, according to a second embodiment of the present invention with reference to FIG. 11. Each unit with a number shown in FIG. 11 corresponds to a unit with the same number in FIG. 10. The network-gateway device 30 includes a memory 33 and a gateway-arithmetic-operation unit 34 in addition to the PHS-base-station-connection interface 32. The IP phone 50 includes a memory 51 for storing its authentication code therein. The network-gatekeeper device 60 includes an address-information-extracting unit 61 and a gatekeeper-arithmetic-operation unit 62. Initially at a step S61 shown in FIG. 11, the PBX 40 registers the authentication code of the IP phone 50 in its station data 42. As shown in FIG. 11, the PBX 40 registers a number “3257482381” as the authentication code for the IP phone 50 having the extension number 3001 so that the PBX 40 executes an authentication process of the IP phone 50 each time the IP phone 50 requests the PBX 40 for its location registration, transmits a call, or receives a call. In other words, the authentication system provided in the centralized PHS system becomes valid by registering the authentication code of the IP phone 50 in the station data 42. The IP phone 50 stores the authentication code in its memory 51 at a step S62.

When transmitting a control signal such as the IP-terminal-location-registration-request message to the network-gatekeeper device 60 or to the network-gateway device 30, the IP phone 50 also transmits the authentication code stored in its memory 51 with the control signal at a step S63. After receiving the control signal from the IP phone 50, the network-gatekeeper device 60 checks whether the authentication code is received with the control signal from the IP phone 50. If it is ascertained that the authentication code is included in the control signal received from the IP phone 50 by the network-gatekeeper device 60, the network-gatekeeper device 60 transmits the authentication code to the network-gateway device 30 at a step S64. If it is ascertained that the authentication code is not included in the control signal from the IP phone 50, the network-gatekeeper device 60 extracts address information specifically provided to the IP phone 50 such as its IP address or its MAC (Media Access Control) address from the control signal received from the IP phone 50 by use of the address-information-extracting unit 61 located therein. Since the extracted address information has a different number of digits from that of the authentication code, and cannot be used as the authentication code, the network-gatekeeper device 60 executes a specific arithmetic operation on the extracted address information by use of the gatekeeper-arithmetic-operation unit 62 in order to make the extracted address information have the same number of digits as the authentication code. Subsequently, at the step S64, the network-gatekeeper device 60 transmits the address information as the authentication code of the IP phone 50 to the network-gateway device 30 after executing the specific arithmetic operation. The address information such as the IP address or the MAC address of the IP phone is substituted for the authentication code in a case that the IP phone 50 does not include the authentication code or does not have a function to transmit the authentication code to the network-gatekeeper device 60. The address-information-extracting unit 61 and the gatekeeper-arithmetic-operation unit 62 provided in the network-gatekeeper device 60 may also be provided in the network-gateway device 30 so that the network-gateway device 30 can obtain the address information directly from the IP phone 50.

Subsequently, the network-gateway device 30 receives the authentication code from the network-gatekeeper device 60 or from the IP phone 50, and stores the authentication code temporarily in its memory 33. After receiving the authentication random number that is generated at the step S41 in FIG. 9 by the PBX 40, the network-gateway device 30 executes an arithmetic operation based on the authentication random number received from the PBX 40 and the authentication code temporarily stored in the memory 33 by use of the gateway-arithmetic-operation unit 34, and then transmits the result of the arithmetic operation to the PBX 40 at a step S65. The PBX 40 compares the result of the arithmetic operation received from the network-gateway device 30 and the result of the arithmetic operation executed therein in the procedure shown in FIG. 9. If the authentication of the IP phone 50 was successful, the PBX can execute the location registration of the IP phone 50 as described with reference to FIG. 10. Whether the authentication of the IP phone 50 was successful or not, the result of the authentication is transmitted to the IP phone 50 as described in the first embodiment.

According to the present invention as described above, the network-gateway device 30 executes the processes necessary for authenticating the IP phone 50 that are supposed to be executed by the IP phone 50 in the centralized PHS system, and the network-gatekeeper device 60 generates the authentication code for the IP phone 50 base on the address information of the IP phone 50. Therefore, even if the IP phone 50 does not include the authentication code therein, the PBX 40 can register the IP phone 50 therein, and can connect the IP phone 50 to the IP network. Additionally, unauthorized use of the IP phone 50 can be prevented since the network-gatekeeper device 60 transmits the authentication code of the IP phone 50 to the network-gateway deice 30 so that the authentication processes can be executed by the network-gateway device 30 and the PBX 40.

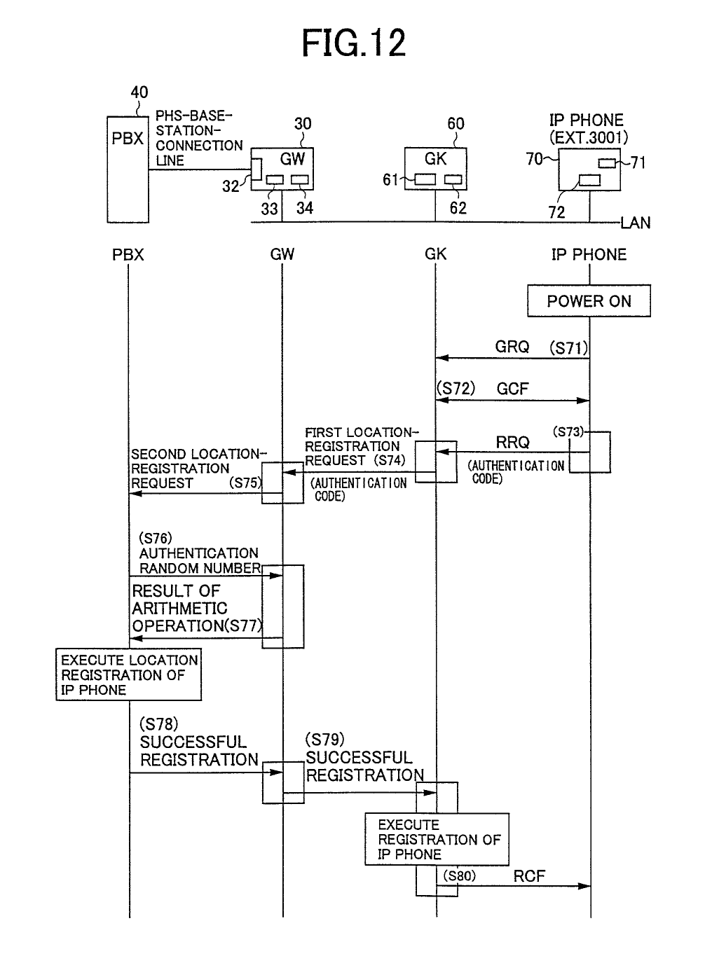

A description will now be given of a third embodiment of the present invention, wherein an IP phone includes a function to store an authentication code therein. The third embodiment of the present invention shows a combination of the authentication process of the IP phone and the location registration process of the IP phone. FIG. 12 is a block diagram showing a sequence of processes executed by devices in an IP-terminal-device-registration system. Each unit with a number shown in FIG. 12 corresponds to a unit with the same number in FIG. 11. FIG. 12 additionally shows an IP phone 70 having the extension number 3001. The IP phone 70 includes a memory 71 and a DHCP-client unit 72. The IP phone 70 obtains an IP address from a DHCP (Dynamic Host Configuration Protocol) server by use of the DHCP-client unit 72 when the IP phone 70 is powered on, and transmits and receives IP packets by use of the obtained IP address. An extension number and an authentication code of the IP phone 70 are set by a user operating a keyboard or keys attached to the IP phone 70, and are stored in the memory 71 of the IP phone 70 until the extension number and the authentication code are set to other values afterward. The IP phone 70 is initially registered as a PHS phone having the extension number 3001 and its authentication code in the PBX 40. A PHS-base-station-connection line belongs to a call area which area number is “1”.

At a step S71 shown in FIG. 12, the IP phone 70 transmits a GRQ (Gatekeeper ReQuest) message to addresses that are used for locating the network-gatekeeper device 60 by use of a multicast technology, in order to receive an IP address of the network-gatekeeper device 60. Subsequently, the network-gatekeeper device 60 transmits a GCF (Gatekeeper ConFirm) message including its own IP address to the IP phone 70 at a step S72. After receiving the IP address from the network-gatekeeper device 60, the IP phone 70 transmits a RRQ (Registration ReQuest) message to the network-gatekeeper device 60 at a step S73 to register itself as a terminal device of the PBX 40. The RRQ message includes the extension number 3001, the IP address, and the authentication code of the IP phone 70.

After receiving the RRQ message from the IP phone 70, the network-gatekeeper device 60 transmits a first location-registration-request message including the extension number 3001 and the authentication code of the IP phone 70 to the network-gateway device 30 at a step S74. Subsequently the network-gateway device 30 stores the authentication code included in the first location-registration-request message received from the network-gatekeeper device 60 in its memory 33 as well as transmits a second location-registration-request message that includes the extension number 3001 to the PBX 40 at a step S75. When the second location-registration-request message has arrived at the PBX 40, the PBX 40 generates a random number as an authentication random number, and executes an arithmetic operation based on the authentication random number and the authentication code stored therein that corresponds to the extension number 3001. The PBX 40 transmits the authentication random number to the network-gateway device 30 at a step S76 as well as temporarily storing the result of the arithmetic operation therein.

The network-gateway device 30 also executes the arithmetic operation based on the authentication random number received from the PBX 40 and the authentication code temporarily stored in its memory 33 by use of its gateway-arithmetic-operation unit 34, and transmits the result of the arithmetic operation to the PBX 40 at a step S77. Subsequently, the PBX 40 receives the result of the arithmetic operation executed by the network-gateway device 30 from the network-gateway device 30, and compares the result of the arithmetic operation executed by the network-gateway device 30 with result of the arithmetic operation executed by the PBX 40 temporarily stored therein. The results are the same in the third embodiment of the present invention, and thus the PBX 40 registers the area number “1”, of the call area wherein the PHS-base-station-connection line is located, as a call area for the extension number 3001. Additionally, the PBX 40 transmits a registration-result-notification message indicating the successful location registration of the IP phone 70, to the network-gateway device 30 at a step S78. Subsequently, the network-gateway device 30 transmits the registration-result-notification message indicating the successful location registration of the IP phone 70 to the network-gatekeeper device 60 at a step S79. The network-gatekeeper device 60 registers a combination of the extension number 3001 included in the GRQ message received from the IP phone 70 and the IP address of the IP phone 70 therein, and then transmits a RCF (Registration ConFirm) message to the IP phone 70 at a step S80.

By taking the above-described sequence of processes, the call area used for the PBX 40 to call the IP phone 70 is registered in the PBX 40 by use of the location registration function of the centralized PHS system provided in the PBX 40, and the authentication of the IP phone 70 is executed by use of the authentication function provided in the PBX 40. Additionally, each of the steps S74 and S75 shown in FIG. 12 corresponds to a location-registration-request unit in the claims. Furthermore, each of the steps S78 and S79 shown in FIG. 12 corresponds to a registration-result-notification unit in the claims.

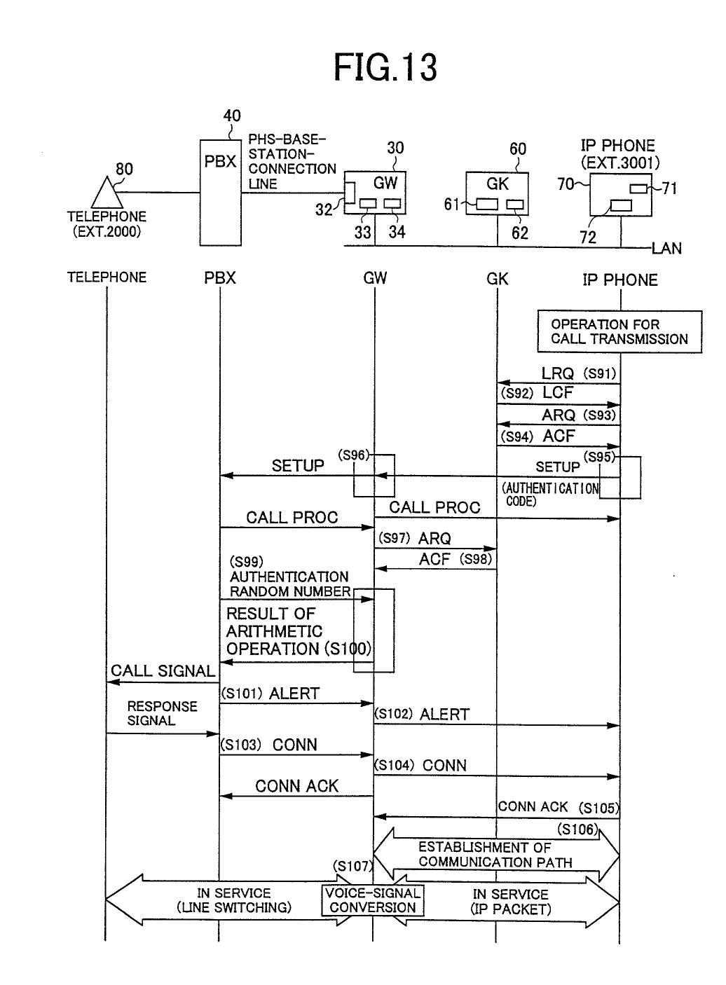

A description will now be given of a sequence of the processes taken by the devices in the IP-terminal-device-registration system when the IP phone 70 transmits a call, according to a fourth embodiment of the present invention with reference to FIG. 13. Each unit with a number shown in FIG. 13 corresponds to a unit with the same number in FIG. 12. Additionally, the fourth embodiment of the present invention includes a telephone set 80 having an extension number 2000.

When a user of the IP phone 70 executes an operation to transmit a call to the telephone set 80 having the extension number 2000, the IP phone 70 transmits an LRQ (Location ReQuest) message to the network-gatekeeper device 60 at a step S91 in order to obtain an IP address of the telephone set 80. The network-gatekeeper device 60 transmits an LCF (Location ConFirm) message including an IP address of the network-gateway device 30 to the IP phone 70 at a step S92 in response to the LRQ message from the IP phone 70. The IP phone 70 then transmits an ARQ (Admission ReQuest) message to the network-gatekeeper device 60 at a step S93, thereby requesting permission to use a specific voice band for communicating with the telephone 80. The network-gatekeeper device 60 permits the use of the specific voice band by returning an ACF (Admission ConFirm) message to the IP phone 70 at a step S94. The IP phone 70 then transmits a SETUP message including the extension number 2000 and an authentication code stored in its memory 71 to the network-gateway device 30 at a step S95.

The network-gateway device 30 stores the authentication code received from the IP phone 70 temporarily in its memory 33, and transmits the SETUP message including the extension number 2000 to the PBX 40 and a CALLPROC message to the IP phone 70 at a step S96. At a step S97, the network-gateway device 30 transmits the ARQ message to the network-gatekeeper device 60, thereby requesting permission to use the specific voice band for communicating with the telephone 80. The network-gatekeeper device 60 permits the use of the specific voice band by transmitting the ACF message to the network-gateway device 30 at a step S98. After receiving the SETUP message from the network-gateway device 30, the PBX 40 transmits the CALLPROC message to the network-gateway device 30, generates a random number as an authentication random number, and then transmits the generated authentication random number to the network-gateway device 30 at a step S99. Additionally, the PBX 40 executes an arithmetic operation based on the generated authentication random number and an authentication code stored therein that corresponds to the extension number 3001, and temporarily stores the result of the arithmetic operation therein. Subsequently, the network-gateway device 30 executes the arithmetic operation based on the authentication random number received from the PBX 40 and the authentication code temporarily stored in the memory 33 by use of the gateway-arithmetic-operation unit 34, and transmits the result of the arithmetic operation to the PBX 40 at a step S100.

The PBX 40 compares the result of the arithmetic operation temporarily stored therein and the result of the arithmetic operation received from the network-gateway device 30. Since the results are the same in the fourth embodiment of the present invention, the PBX 40 continues a call-establishment process. The PBX 40 calls the telephone set 80 connected to the PBX 40, and calls the network-gateway device 30 by transmitting an ALERT message thereto at a step S101. The network-gateway device 30 then calls the IP phone 70 by transmitting the ALERT message to the IP phone 70 at a step S102. When the telephone set 80 has responded to the call from the PBX 40, the PBX 40 transmits a CONN message indicating the telephone set 80 has responded to the call by the PBX 40 to the network-gateway device 30 at a step S103. After receiving the CONN message from the PBX 40, at a step S104, the network-gateway device 30 notifies the PBX 40 about reception of the CONN message by transmitting a CONN-ACK message to the PBX 40 as well as transmits the CONN message to the IP phone 70. When the CONN message has arrived at the IP phone 70, the IP phone 70 transmits the CONN-ACK message to the network-gateway device 30 at a step S105, thereby notifying the network-gateway device 30 about the reception of the CONN message from the network-gateway device 30.

At a step S106, establishment of a communication path between the network-gateway device 30 and the IP phone 70 is executed for transmitting voice signals to each other by use of IP packets. Accordingly, a communication path between the IP phone and the telephone set 80 is established, and becomes in service at a step S107. The voice signals are exchanged between the network-gateway device 30 and the telephone set 80 by line switching, and the voice signals are exchanged between the network-gateway device 30 and the IP phone 70 by use of the IP packets. The network-gateway device 30 converts the above-described two different types of the voice signals to each other.

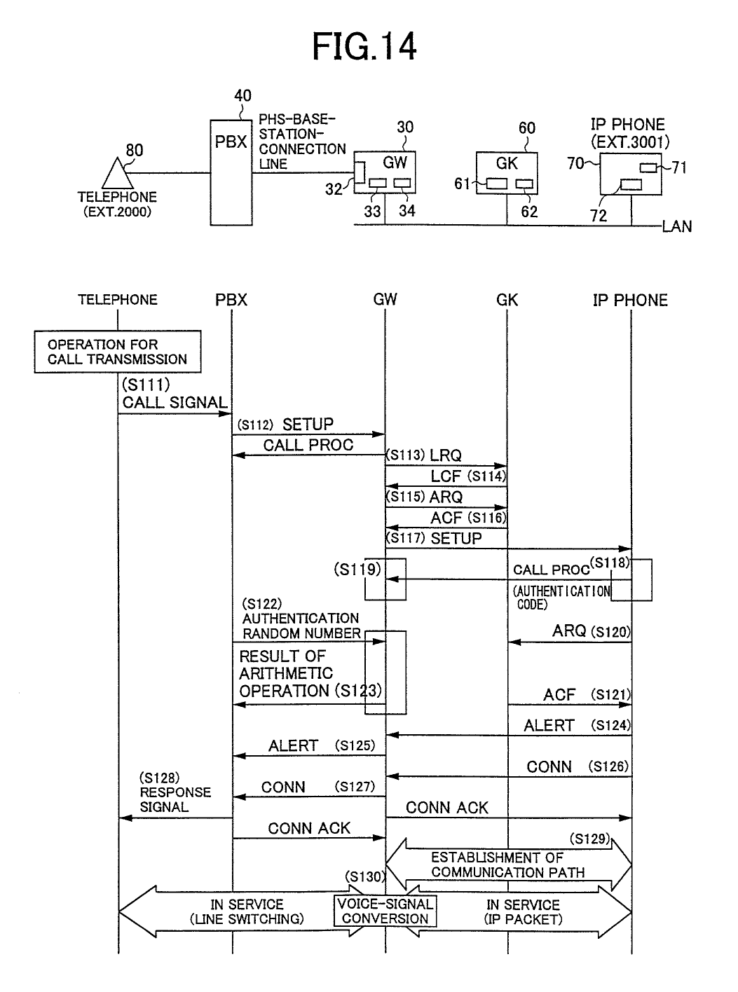

A description will now be given of a sequence of processes taken by the devices in the IP-terminal-device-registration system when the IP phone 70 receives a call, according to a fifth embodiment of the present invention with reference to FIG. 14. Each unit with a number shown in FIG. 14 corresponds to a unit with the same number in FIG. 13.

When a user of the telephone set 80 executes an operation to transmit a call to the IP phone 70 having the extension number 3001, the telephone set 80 transmits a call signal to the PBX 40 at a step S111. The PBX 40 transmits the SETUP message including the extension number 3001 to a line having an extension number 3000, that is, the network-gateway device 30 at a step S112, since the extension number 3001 is an inward-dialing number of the extension number 3000. Subsequently, the network-gateway device 30 returns the CALLPROC message to the PBX 40 as well as transmits the LRQ message to the network-gatekeeper device 60 at a step S113 in order to obtain the IP address of the IP phone 70. After receiving the LRQ message from the network-gateway device 30, the network-gatekeeper device 60 returns the LCF message including the IP address of the IP phone 70 to the network-gateway device 30 at a step S114. The network-gateway device 30 then transmits the ARQ message to the network-gatekeeper device 60 at a step S115, thereby requesting permission to use a specific voice band for communication between the IP phone 70 and the telephone set 80. The network-gatekeeper device 60 permits the use of the specific voice band by returning the ACF message to the network-gateway device 30 at a step S116. After receiving the ACF message from the network-gatekeeper device 60, the network-gateway device 30 transmits the SETUP message to the IP address of the IP phone 70 at a step S117. When the SETUP message has arrived at the IP phone 70, the IP phone transmits the CALLPROC message including the authentication code of the IP phone 70 stored in its memory 71, to the network-gateway device 30 at a step S118. Subsequently, the network-gateway device 30 stores the authentication code of the IP phone 70 temporarily in its memory 33 at a step S119.

The IP phone 70 then transmits the ARQ message to the network-gatekeeper device 60 at a step S120, thereby requesting permission to use the specific voice band for communicating with the telephone 80. The network-gatekeeper device 60 permits the use of the specific voice band by returning the ACF message to the IP phone 70 at a step S121. The PBX 40 generates a random number as the authentication random number, and then transmits the generated authentication random number to the network-gateway device 30 at a step S122. Additionally, the PBX 40 executes an arithmetic operation based on the generated authentication random number and an authentication code stored therein that corresponds to the extension number 3001, and temporarily stores the result of the arithmetic operation therein. Subsequently, the network-gateway device 30 executes the arithmetic operation based on the authentication random number received from the PBX 40 and the authentication code temporarily stored in the memory 33 by use of the gateway-arithmetic-operation unit 34, and transmits the result of the arithmetic operation to the PBX 40 at a step S123. The PBX 40 compares the result of the arithmetic operation temporarily stored therein and the result of the arithmetic operation received from the network-gateway device 30. Since the results are the same in the fifth embodiment of the present invention, the PBX 40 continues a call-establishment process.

The IP phone 70 transmits the ALERT message to the network-gateway device 30 when the IP phone 70 starts ringing at step S124. The network-gateway device 30 transmits the ALERT message to the PBX 40 at a step S125 after receiving the ALERT message from the IP phone 70. When a user of the IP phone 70 answers the call from the telephone set 80, the IP phone 70 transmits the CONN message to the network-gateway device 30 at a step S126. Subsequently, the network-gateway device 30 returns the CONN-ACK message to the IP phone 70 after receiving the CONN message from the IP phone 70 as well as transmits the CONN message to the PBX 40 at a step S127. The PBX 40 transmits the CONN-ACK message to the network-gateway device 30 in response to the CONN message from the network-gateway device 30 as well as transmits a response signal indicating that the IP phone 70 has answered the call from the telephone set 80, to the telephone set 80 at a step S128. At a step S129, establishment of a communication path between the network-gateway device 30 and the IP phone 70 is executed for transmitting voice signals to each other by use of IP packets. Accordingly, a communication path between the IP phone and the telephone set 80 is established, and becomes in service at a step S130. The voice signals are exchanged between the network-gateway device 30 and the telephone set 80 by line switching, and the voice signals are exchanged between the network-gateway device 30 and the IP phone 70 by use of the IP packets. The network-gateway device 30 converts the above-described two different types of the voice signals to each other.

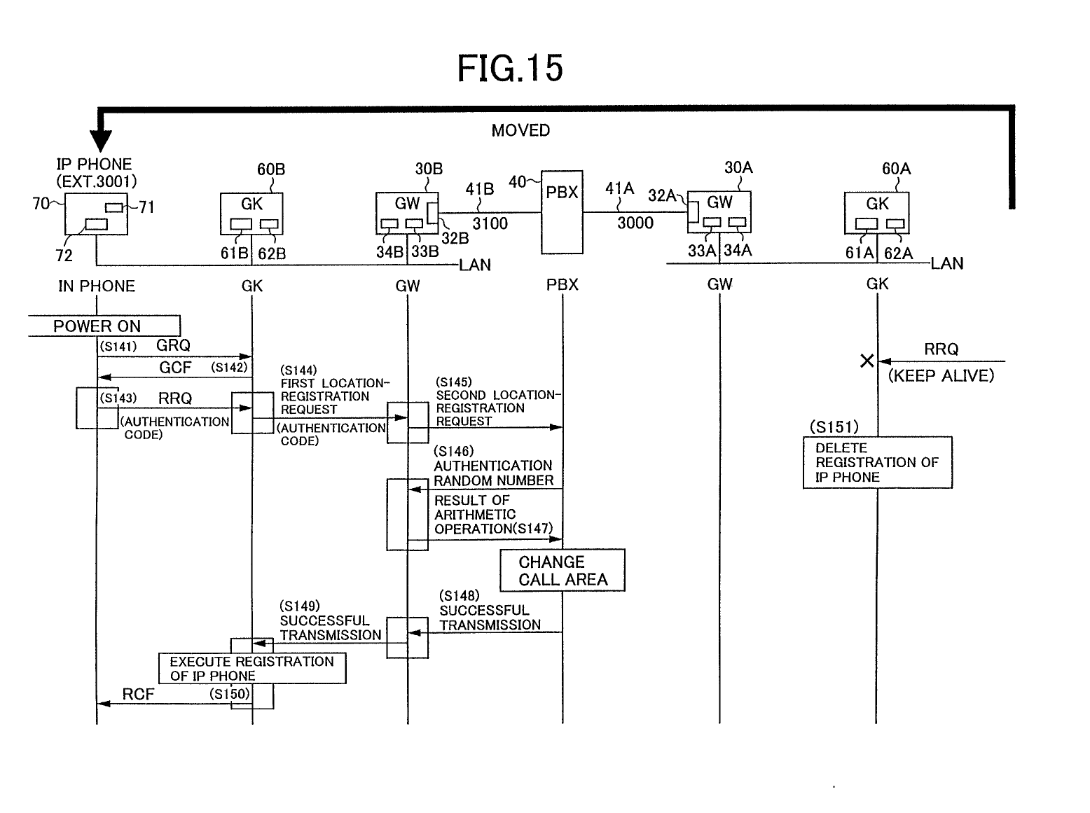

A description will now be given of a sequence of the processes taken by the devices according to the present invention when the IP phone 70 is moved to another call area, according to a sixth embodiment of the present invention with reference to FIG. 15. Each unit with a number shown in FIG. 15 corresponds to a unit with the same number in FIG. 14. Additionally, a system shown in FIG. 15 includes network-gateway devices 30A and 30B, PHS-base-station-connection lines 41A and 41B, and network-gatekeeper devices 60A and 60B. The network-gateway device 30A includes a PHS-base-station-connection interface 32A, a memory 33A and a gateway-arithmetic-operation unit 34A. The network-gateway device 30B includes a PHS-base-station-connection interface 32B, a memory 33B and a gateway-arithmetic-operation unit 34B. The network-gatekeeper device 60A includes an address-information-extracting unit 61A and a gatekeeper-arithmetic-operation unit 62A. The network-gatekeeper device 60B includes an address-information-extracting unit 61B and a gatekeeper-arithmetic-operation unit 62B. The extension number of the PHS-base-station-connection lines 41A and 41B are respectively 3000 and 3100. The PHS-base-station-connection line 41A, the network-gateway device 30A and the network-gatekeeper device 60A are located in a call area 1. On the other hand, the PHS-base-station-connection line 41B, the network-gateway device 30B and the network-gatekeeper device 60B are located in a call area 2. The following steps describe the IP phone 70 moving from the call area 1 to the call area 2.

At a step S141 shown in FIG. 15, the IP phone 70 transmits the GRQ message to addresses that are used for locating the network-gatekeeper device 60B by use of the multicast technology, in order to receive an IP address of the network-gatekeeper device 60B. Subsequently, the network-gatekeeper device 60B transmits the GCF message including its own IP address to the IP phone 70 at a step S142. After receiving the IP address from the network-gatekeeper device 60B, the IP phone 70 transmits the RRQ message to the network-gatekeeper device 60B at a step S143 to register itself as a terminal device of the PBX 40. The RRQ message includes the extension number 3001, the IP address, and the authentication code of the IP phone 70.

After receiving the RRQ message from the IP phone 70, the network-gatekeeper device 60B transmits the first location-registration-request message including the extension number 3001 and the authentication code of the IP phone 70 to the network-gateway device 30B at a step S144. Subsequently the network-gateway device 30B temporarily stores the authentication code included in the first location-registration-request message received from the network-gatekeeper device 60B in its memory 33B as well as transmits the second location-registration-request message that includes the extension number 3001 to the PBX 40 at a step S145. When the second location-registration-request message has arrived at the PBX 40, the PBX 40 generates a random number as an authentication random number, and executes an arithmetic operation based on the authentication random number and the authentication code stored therein that corresponds to the extension number 3001. The PBX 40 then transmits the authentication random number to the network-gateway device 30B at a step 146 as well as temporarily stores the result of the arithmetic operation therein.

The network-gateway device 30B also executes the arithmetic operation based on the authentication random number received from the PBX 40 and the authentication code temporarily stored in its memory 33B by use of its gateway-arithmetic-operation unit 34B, and transmits the result of the arithmetic operation to the PBX 40 at a step S147. Subsequently, the PBX 40 receives the result of the arithmetic operation executed by the network-gateway device 30B from the network-gateway device 30B, and compares the result of the arithmetic operation executed by the network-gateway device 30B with the result of the arithmetic operation executed by the PBX 40 temporarily stored therein. The results are the same in the sixth embodiment of the present invention, and thus the PBX 40 registers the area number “2” of the call area 2 wherein the PHS-base-station-connection line 41B having an extension number 3100 is located, as a call area for the extension number 3001. Additionally, the PBX 40 transmits the registration-result-notification message indicating the successful location registration of the IP phone 70, to the network-gateway device 30B at a step S148. Subsequently, the network-gateway device 30B transmits the registration-result-notification message indicating the successful location registration of the IP phone 70 to the network-gatekeeper device 60B at a step S149. The network-gatekeeper device 60B registers a combination of the extension number 3001 included in the GRQ message received from the IP phone 70 and the IP address of the IP phone 70 therein, and then transmits the RCF message to the IP phone at a step S150.

Since the IP phone 70 is moved from the call area 1 to the call area 2, the network-gatekeeper device 60A in the call area 1 does not receive the RRQ message including a keep-alive bit set high from the IP phone 70. Thus, at a step S151, the network-gatekeeper device 60A deletes the registration of the IP phone 70 therefrom after not receiving the RRQ message including the keep-alive bit set high from the IP phone 70 for a certain period, for instance, several minutes or several hours. The network-gatekeeper devices 60A and 60B include a function to direct the IP phone 70 to transmit the RRQ message including the keep-alive bit set high to the network-gatekeeper devices 60A and 60B, in order to check which call area the IP phone is located in.

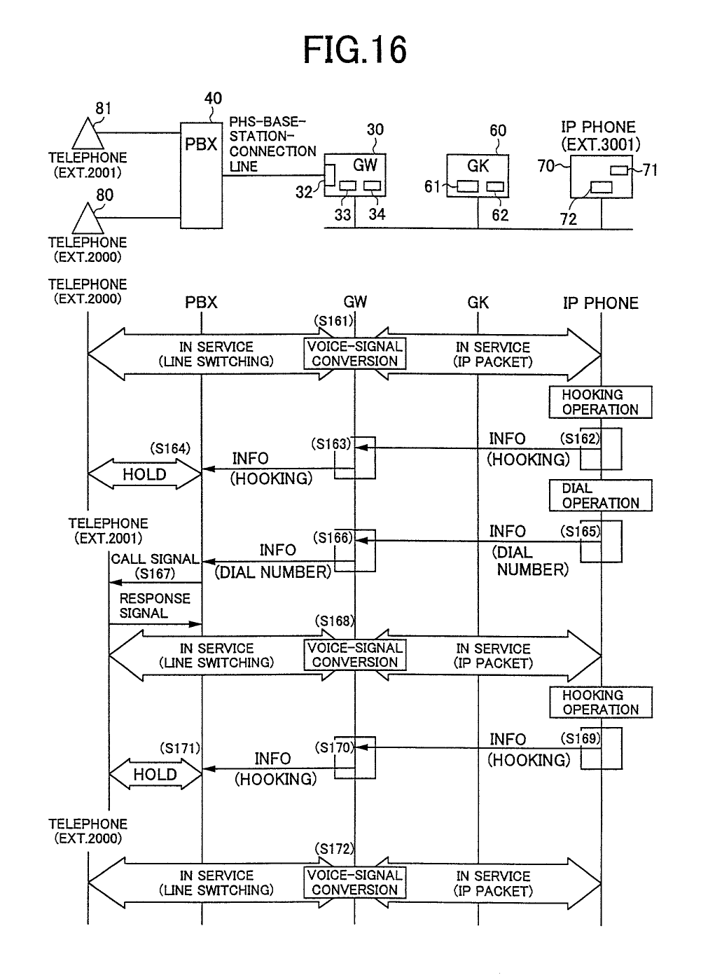

A description will now be given of a procedure to start up a call-switching service provided by the PBX by use of the network-gateway device according to a seventh embodiment of the present invention with reference to FIG. 16. In this embodiment, the network-gateway device transmits information as a sign of a hooking signal and an additional dial number to the PBX so that the PBX can start up a variety of services such as the call-switching service. Each unit with a number shown in FIG. 16 corresponds to a unit with the same number in FIG. 14. Additionally, a system shown in FIG. 16 includes a telephone set 81 having an extension number 2001.

It is assumed that a line between the IP phone 70 and the telephone set 80 is in service initially at a step S161 shown in FIG. 16. When a user of the IP phone 70 executes a hooking operation, the IP phone 70 transmits an INFO (information) message including the information as a sign of the hooking signal to the network-gateway device 30 at a step S162. After receiving the INFO message from the IP phone 70, the network-gateway device 30 transmits the INFO message to the PBX 40 at a step S163. The PBX 40 receives the INFO message from the network-gateway device 30, and holds a line between the PBX and the telephone set 80 at a step S164.

When the user of the IP phone 70 executes a dialing operation, the IP phone 70 transmits the INFO message including information about the number dialed by the user, that is, the extension number 2001, to the network-gateway device 30 at a step S165. After receiving the INFO message from the IP phone 70, the network-gateway device 30 transmits the INFO message to the PBX 40 at a step S166. The PBX 40 then calls the telephone set 81 at the extension number 2001 at a step S167 after receiving the INFO message from the network-gateway device 30. When the telephone set 81 replies to the call from the PBX 40, the IP phone 70 and the telephone set 81 become connected to each other through the PBX 40 at a step S168. If the user of the IP phone 70 executes the hooking operation while the IP phone 70 and the telephone set 81 are connected to each other, the IP phone 70 transmits the INFO message including the information as a sign of the hooking signal to the network-gateway device 30 at a step S169. At a step S170, the network-gateway device 30 transmits the INFO message received from the IP phone 70 to the PBX 40. Subsequently, the PBX 40 holds a line between the PBX 40 and the telephone set 81, and cancels the holding of the line between the PBX 40 and the telephone set 80 at a step S171. At a step S172, the line between the IP phone 70 and the telephone set 80 becomes in service again. It should be noted that the IP phone must include a function to transmit the INFO message including the hooking signal and the dial number in order to start up the service provided by the PBX.

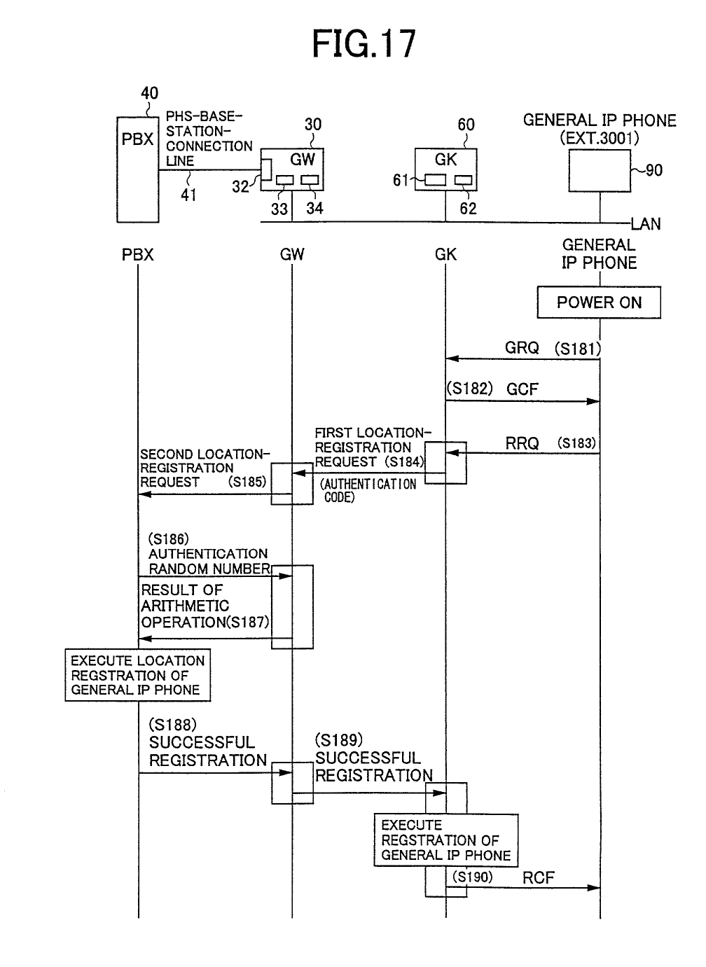

A description will now be given of an authentication method and a location registration method of a conventional IP phone (general IP phone) provided on the IP network according to an eighth embodiment of the present invention with reference to FIG. 17. Each unit with a number shown in FIG. 17 corresponds to a unit with the same number in FIG. 16. Additionally, a general IP phone 90 having the extension number 3001 is provided on the IP network as shown in FIG. 17. The general IP phone 90 does not store an authentication code therein, and has a function as a DHCP client. The general IP phone 90 receives an IP address from a DHCP server when the general IP phone 90 is turned on, and uses the IP address received from the DCHP server to transmit and receive IP packets. Additionally, the general IP phone 90 sets its extension number by use of a keyboard provided thereto, and stores the extension number in its internal memory until the next extension number update. Furthermore, the general IP phone 90 does not include a function to set and store the authentication code, and cannot start up supplementary services provided by the PBX by use of a hooking signal and an additional dial number. However, the authentication function of the centralized PHS system may be used for authenticating the general IP phone 90 by use of a value calculated from a MAC address of the general IP phone 90 as the authentication code thereof.

Thus, the general IP phone 90 may be authenticated similarly as the previously described IP phone 70. The extension number 3001 is stored in the PBX 40 as an extension number of a PHS phone, and the value calculated from the MAC address of the general IP phone 90 is set as the authentication code corresponding to the extension number 3001. Additionally, the PHS-base-station-connection line 41 belongs to the call area 1.

At a step S181 shown in FIG. 17, the general IP phone 90 transmits the GRQ message to addresses that are used for locating the network-gatekeeper device 60 by use of the multicast technology, in order to receive an IP address of the network-gatekeeper device 60. Subsequently, the network-gatekeeper device 60 transmits the GCF message including its own IP address to the general IP phone 90 at a step S182. After receiving the IP address from the network-gatekeeper device 60, the general IP phone 90 transmits the RRQ message to the network-gatekeeper device 60 at a step S183 to register itself as a terminal device of the PBX 40. The RRQ message includes the extension number 3001, the IP address, and the IP address of the general IP phone 90.

After receiving the RRQ message from the general IP phone 90, the network-gatekeeper device 60 calculates the authentication code of the general IP phone 90 from the MAC address of the general IP phone 90, and transmits the first location-registration-request message including the extension number 3001 and the authentication code of the general IP phone 90 to the network-gateway device 30 at a step S184. Subsequently the network-gateway device 30 temporarily stores the authentication code included in the first location-registration-request message received from the network-gatekeeper device 60 in its memory 33 as well as transmits the second location-registration-request message that includes the extension number 3001 to the PBX 40 at a step S185. When the second location-registration-request message has arrived at the PBX 40, the PBX 40 generates a random number as an authentication random number, and executes an arithmetic operation based on the authentication random number and the authentication code stored therein that corresponds to the extension number 3001. The PBX 40 transmits the authentication random number to the network-gateway device 30 at a step S186 as well as temporarily stores the result of the arithmetic operation therein.

The network-gateway device 30 also executes the arithmetic operation based on the authentication random number received from the PBX 40 and the authentication code temporarily stored in its memory 33 by use of its gateway-arithmetic-operation unit 34, and transmits the result of the arithmetic operation to the PBX 40 at a step S187. Subsequently, the PBX 40 receives the result of the arithmetic operation executed by the network-gateway device 30 from the network-gateway device 30, and compares the result of the arithmetic operation executed by the network-gateway device 30 with result of the arithmetic operation executed by the PBX 40 temporarily stored therein. The results are the same in the eighth embodiment of the present invention, and thus the PBX 40 registers the area number “1” of the call area wherein the PHS-base-station-connection line 41 is located, as a call area for the extension number 3001. Additionally, the PBX 40 transmits the registration-result-notification message indicating the successful location registration of the general IP phone 90, to the network-gateway device 30 at a step S188. Subsequently, the network-gateway device 30 transmits the registration-result-notification message indicating the successful location registration of the general IP phone 90 to the network-gatekeeper device 60 at a step S189. The network-gatekeeper device 60 registers a combination of the extension number 3001 included in the GRQ message received from the general IP phone 90 and the IP address of the general phone 90 therein, and then transmits the RCF message to the general IP phone 90 at a step S190.

By taking the above-described sequence of the processes, the call area used for the PBX 40 to call the general IP phone 90 is registered in the PBX 40 by use of the location registration function of the centralized PHS system provided in the PBX 40, and the authentication of the general IP phone 90 is executed by use of the authentication function provided in the PBX 40. When the general IP phone 90 is moved to another call area, the steps taken for registering and updating location information of the general IP phone 90 is similar to the sixth embodiment with reference to FIG. 15 and to the above-described eighth embodiment of the present invention so that the explanation of the steps are omitted.

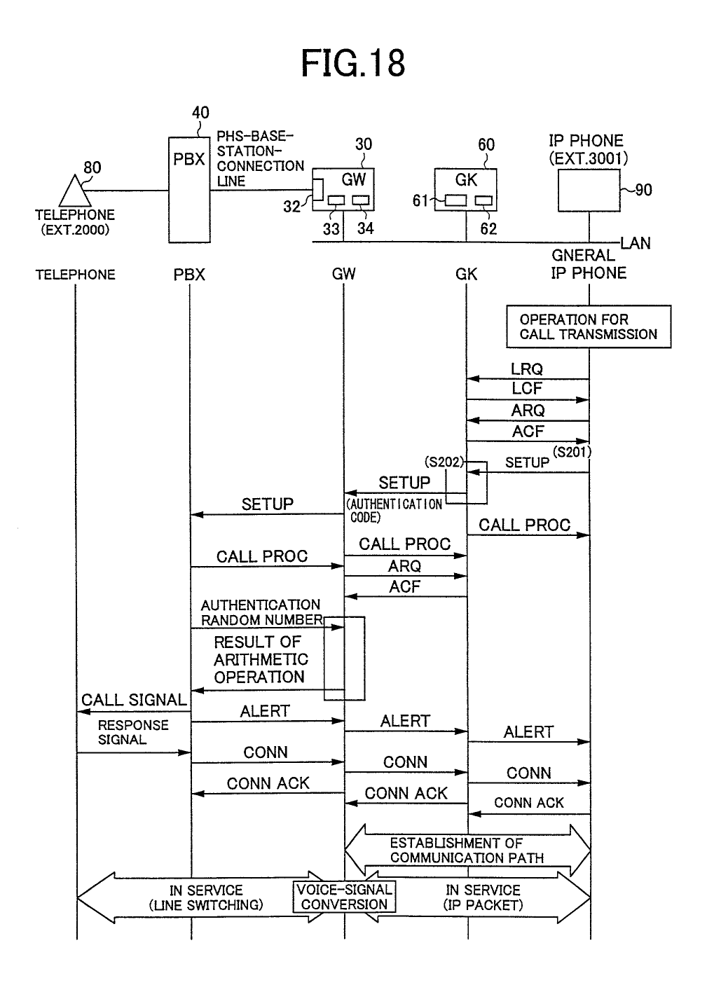

A description will now be given of a sequence of the processes taken by the devices in the IP-terminal-device-registration system when the general IP phone 90 calls the telephone set 80, according to a ninth embodiment of the present invention with reference to FIG. 18. Each unit with a number shown in FIG. 18 corresponds to a unit with the same number in FIGS. 13 and 17. A description will only be given of the difference between the fourth embodiment and the ninth embodiment of the present invention.

The general IP phone 90 transmits the SETUP message including the extension number 2000 to the network-gatekeeper device 60 at a step S201. After receiving the SETUP message from the general IP phone 90, the network-gatekeeper device 60 calculates the authentication code of the general IP phone 90 from the MAC address of the general IP phone 90, and transmits the SETUP message including the extension number 2000 and the authentication code of the general IP phone 90 to the network-gateway device 30 as well as transmits the CALLPROC message to the general IP phone 90 at a step S202. The general IP phone 90 transmits the SETUP message to the network-gatekeeper device 60 so that the network-gatekeeper device 60 can calculate the authentication code of the general IP phone 90 and relay the SETUP message to the network-gateway device 30 in the ninth embodiment, whereas the IP phone 70 transmits the SETUP message to the network-gateway device 30 not through the network-gatekeeper device 60 since the IP phone 70 stores the authentication code therein in the fourth embodiment. The network-gatekeeper device 60 can select a method described in the fourth embodiment or a method described in the ninth embodiment by transmitting the ACF message to a terminal device such as the IP phone 70 and the general IP phone 90 according to the ITU-T H.323. The procedure to notify the network-gateway device 30 about the authentication code of the general IP phone 90 when the general IP phone 90 calls the telephone set 80 is given as described above. Additionally the procedure to receive a call from the telephone set 80 by the general IP phone 90 can be executed similarly by substituting the above-described steps in the fifth embodiment.

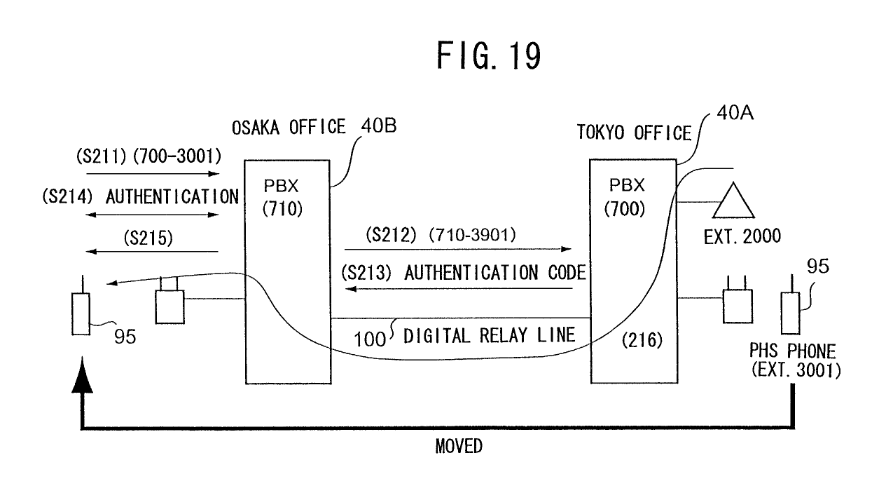

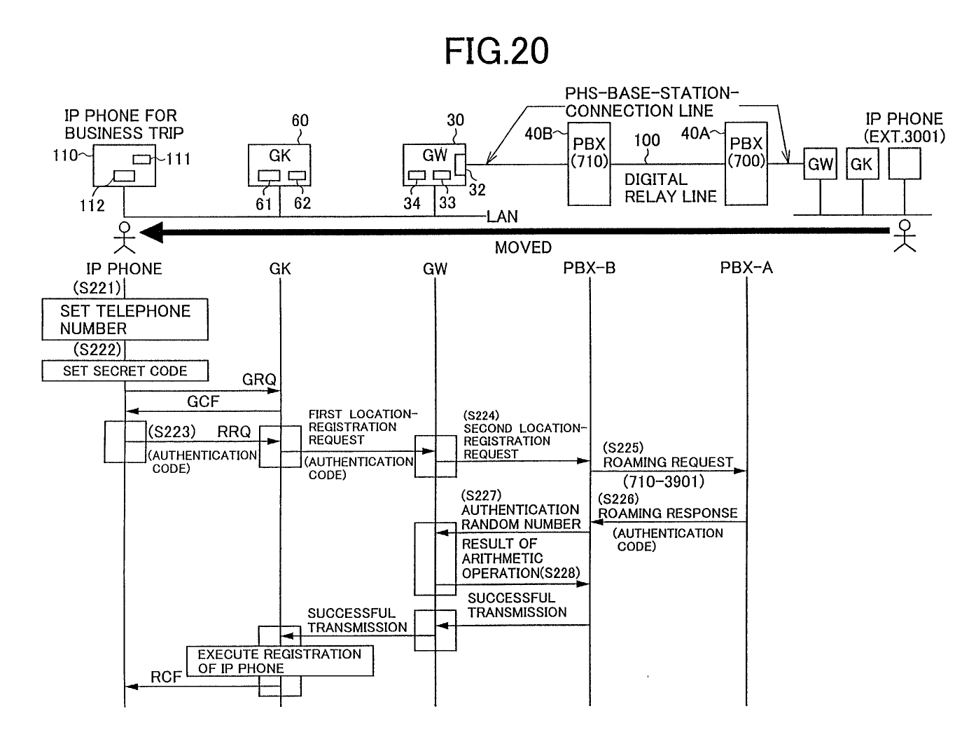

A description will now be given of a tenth embodiment of the present invention with reference to FIGS. 19 and 20. FIG. 19 is a block diagram for describing a roaming function provided by the centralized PHS system. In FIG. 19, a PBX 40A and a PBX 40B are located physically apart from each other, and are connected by a digital relay line 100. For instance, the PBX 40A having its telephone-exchange number set to 700 is placed in a Tokyo office, and the PBX 40B having its telephone-exchange number set to 710 is placed in an Osaka office. The following steps are taken when a user of a PHS phone 95 having the extension number 3001 has moved from the Tokyo office to the Osaka office.

The PHS phone 95 initially transmits a location-registration signal including the telephone-exchange number of the PBX 40A where the PHS phone belongs to, that is, 700, and its extension number 3001 (700-3001) to the PBX 40B at a step S211. After receiving the location-registration signal from the PHS phone 95, the PBX 40B allots a temporary extension number, for example, 3901, to the PHS phone 95 since the number 700-3001 received from the PHS phone 95 is not a telephone number of a PHS phone that belongs to the PBX 40B. Subsequently, the PBX 40B transmits a roaming-request signal including the telephone-exchange number 710 of the PBX 40B and the temporary extension number 3901 (710-3901) to the PBX 40A at a step S212. The PBX 40A registers the telephone number 710-3901 as a forwarding address of the extension number 3001 after receiving the roaming-request from the PBX 40B, and then transmits an authentication code that is stored therein and corresponds to the extension number 3001 to the PBX 40B at a step S213. The PBX 40B registers the authentication code received from the PBX 40A as a temporary authentication code for the extension number 3901, and executes authentication of the PHS phone 95 at a step S214. If the authentication of the PHS phone 95 was successful, the PBX 40B notifies the PHS phone 95 about the successful location-registration of the PHS phone 95 at a step S215. Accordingly, the PHS phone 95 can transmit and receive a call as a PHS phone that belongs to the PBX 40B having an extension number 3901.

When a telephone set that belongs to the PBX 40A having the extension number 2000 dials the extension number 3001 to call the PHS phone 95, the PBX 40A redirects the call from the telephone set having the extension number 2000 to the PHS phone 95 having its telephone number set temporarily to 710-3901 through the digital relay line 100 and the PBX 40B. According to the roaming function provided by the centralized PHS system, the user of the PHS phone 95 can receive calls that are addressed to its original extension number 3001 even if the PHS phone 95 is located at another PBX (PBX 40B), and is provided with another extension number.

FIG. 20 is a block diagram for describing a combination of the roaming function provided by the centralized PHS system and the present invention, according to the tenth embodiment. A user must carry a PHS phone according to the above-described roaming function provided by the centralized PHS system. However, in this embodiment, the user can use an IP phone provided in an office instead of carrying the PHS phone, and can still use the roaming function of the centralized PHS system. Each unit with a number shown in FIG. 20 corresponds to a unit with the same number in FIGS. 18 and 19. Additionally, a system shown in FIG. 20 includes an IP phone 105 with its extension number set to 3001, and an IP phone 110 that is for a worker on a business trip. The IP phone 110 includes a memory 111 and a DHCP-client unit 112.

A user of the IP phone 105 that belongs to the PBX 40A sets and stores the telephone-exchange number of the PBX 40A and the extension number of the IP phone 105 (700-3001) as a telephone number of the IP phone 110 in the memory 111 of the IP phone 110 at a step S221. At a step S222, the user of the IP phone 105 inputs a secret code as an authentication code of the IP phone 105, and the IP phone 110 stores the secret code in the memory 111 thereof where the authentication code of the IP phone 110 is supposed to be stored. The IP phone 110 then transmits the RRQ message to the network-gatekeeper device 60 at a step S223. The RRQ message includes the telephone number 700-3001 stored in the memory 111 of the IP phone 110, the authentication code of the IP phone 105, and an IP address of the IP phone 110. The network-gateway device 30 stores the authentication code received from the network-gatekeeper device 60 temporarily in its memory 33, and transmits the second location-registration-request message including the telephone number 700-3001 to the PBX 40B at a step S224. The PBX 40B allots a temporary extension number 3901 to the IP phone 110, and transmits the roaming-request signal including a temporary telephone number of the IP phone 110 that is 710-3901 to the PBX 40A through the digital-relay line 100 at a step S225.

After receiving the roaming-request signal from the PBX 40B, the PBX 40A registers the telephone number 710-3901 as a forwarding address of the extension number 3001, and transmits a roaming-reply signal including the authentication code that is stored in the PBX 40A and corresponds to the extension number 3001, to the PBX 40B at a step S226. The PBX 40B stores the authentication code received from the PBX 40A therein as well as generates a random number as an authentication random number, and then transmits the generated authentication random number to the network-gateway device 30 at a step S227. Additionally, the PBX 40B executes an arithmetic operation based on the authentication number received from the PBX 40A and the generated authentication random number, and temporarily stores the result of the arithmetic operation therein. At a step S228, the network-gateway device 30 executes the arithmetic operation based on the authentication code received from the network-gatekeeper device 60 and the authentication random number received from the PBX 40B, and returns the result of the arithmetic operation to the PBX 40B. The PBX 40B then compares the result of the arithmetic operation stored therein with the result of the arithmetic operation received from the network-gateway device 30. If the results are the same, the PBX 40B registers the IP phone 110 with the authentication code and the extension number of the IP phone 105 therein. Accordingly, the user of the IP phone 105 can substitute the IP phone 110 for the IP phone 105, and can transmit and receive calls by use of the IP phone 110. Additionally, since the temporary telephone number 710-3901 is registered as the forwarding address of the extension number 3001 in the PBX 40A, the PBX 40A can forward calls addressed to the extension number 3001 to the telephone number 710-3901 so that the user of the IP phone 105 can receive the calls addressed to the extension number 3001. Furthermore, since data such as location information of each IP phone stored in the PBX 40A and the PBX 40B are based on location-registration information such as a fixed extension number of each IP phone, the data stored in the PBX 40A and the PBX 40B does not need to be changed or updated even when an IP phone is moved from a call area to another call area.

The present invention enables an authentication of a user by using a secret code entered to an IP phone by the user as well as enables an authentication of the IP phone by using an authentication code provided to each of IP phones. Additionally, the authentication of the user or the IP phone can be disabled by setting a fixed value to the secret code and the authentication code. When a user of a first IP phone moves from a first call area to a second call area, the first IP phone is not necessarily moved to the second call area, since the authentication code and the extension number of a second IP phone in the second call area may be set to the authentication code and the extension number of the first IP phone.

The above description is provided in order to enable any person skilled in the art to make and use the invention and sets forth the best mode contemplated by the inventors of carrying out the invention.

The present invention is not limited to the specially disclosed embodiments and variations, and modifications may be made without departing from the scope and spirit of the invention. .

The present application is based on Japanese Priority Application No. 2000-089830, filed on Mar. 28, 2000, the entire contents of which are hereby incorporated by reference.

What is claimed is:

1. A method of registering an IP (Internet Protocol) terminal device including a function to transmit and receive IP packets, to a line-switching exchanger including a database that is used for managing a type of a telephone set and a telephone number thereof, said method comprising the steps of:
connecting said line-switching exchanger and a network-gateway device by use of a radio-base-station-connection line that is used for connecting radio base stations;
connecting said network-gateway device and said IP terminal device through an IP network; and
registering said IP terminal device as a radiotelephony device in said database.

2. The method as claimed in claim 1, further comprising the steps of:
transmitting location-registration information of said IP terminal device used for registering information about a location of said IP terminal device to said line switching exchanger through said network-gateway device; and
registering location information about said IP terminal device in said database based on the location-registration information of said IP terminal device.

3. A line-switching exchanger provided in an IP-terminal-device-registration system, wherein said line-switching exchanger is connected with a network-gateway device through a radio-base-station-connection line used for connecting radio base stations, said network-gateway device being connected through an IP network to an IP terminal device that includes a function to transmit and receive IP packets, said line-switching exchanger comprising a database used for managing a type and a telephone number of a telephone set, wherein said line-switching exchanger registers the IP terminal device as a radiotelephony device in said database.

4. The line-switching exchanger as claimed in claim 3, wherein said line-switching exchanger registers information about a location of said IP terminal device based on a location-registration-request message supplied from said network-gateway device.

5. The line-switching exchanger as claimed in claim 3, wherein said database initially includes an authentication code for each IP terminal device connected to said line-switching exchanger, said line-switching exchanger comprising an IP-terminal-authentication unit executing authentication of said IP terminal device after receiving a location-registration-request message requesting registration of said IP terminal device to the database from said network-gateway device, by using an authentication code of said IP terminal device corresponding to the location-registration-request message.

6. The line-switching exchanger as claimed in claim 3, wherein said line-switching exchanger is a PBX (Private Branch exchange) device.

7. A network-gatekeeper device provided in an IP-terminal-device-registration system, wherein a line-switching exchanger is connected with a network-gateway device through a radio-base-station-connection line used for connecting radio base stations, and said network-gatekeeper device is connected through an IP network to said network-gateway device and an IP terminal device that includes a function to transmit and receive IP packets, said network-gatekeeper device comprising:
a location-registration-request unit receiving a telephone number and an IP address of said IP terminal device included in an IP-terminal-location-registration-request message that is used for requesting registration of said IP terminal device from said IP terminal device, and transmitting a location-registration-request message that includes the telephone number to said network-gateway device; and
a registration-result-notification unit receiving a result of registering said IP terminal device to said line-switching exchanger from the network-gateway device, and transmitting the result to said IP terminal device.

8. The network-gatekeeper device as claimed in claim 7, wherein said location-registration-request unit receives the IP-terminal-location-registration-request message including an authentication code from said IP terminal device, and transmits the location-registration-request message including said authentication code to said network-gateway device.

9. The network-gatekeeper device as claimed in claim 7, wherein said location-registration-request unit generates an authentication code based on address information of said IP terminal device when receiving the IP-terminal-location-registration-request message that does not include the authentication code from said IP terminal device, and transmits the location-registration-request message including the generated authentication code to said network-gateway device.

10. A network-gateway device provided in an IP-terminal-device-registration system, wherein a line-switching exchanger is connected with said network-gateway device through a radio-base-station-connection line used for connecting radio base stations, and a network-gatekeeper device is connected through an IP network to said network-gateway device and an IP terminal device that includes a function to transmit and receive IP packets, said network-gateway device comprising:
a location-registration-request unit receiving a first location-registration-request message that includes a telephone number of said IP terminal device connected to the IP network from said network-gatekeeper device, and transmitting a second location-registration-request message including said telephone number to said line-switching exchanger; and
a registration-result-notification unit receiving a result of location registration of said IP terminal device from said line-switching exchanger, and transmitting the result to said network-gatekeeper device.

11. The network-gateway device as claimed in claim 10 comprising a memory temporarily storing an authentication code of said IP terminal device when the first location-registration-request message received from said network-gatekeeper device includes the authentication code of said IP terminal device.

12. The network-gateway device as claimed in claim 11 comprising a gateway-arithmetic-operation unit executing an arithmetic operation using the authentication code temporarily stored in said memory and an authentication random number after receiving the authentication random number from said line-switching exchanger, and transmitting a result of the arithmetic operation to said line-switching exchanger.

13. An IP terminal device provided in an IP-terminal-device-registration system wherein a line-switching exchanger is connected with a network-gateway device through a radio-base-station-connection line used for connecting radio base stations, and a network-gatekeeper device is connected through an IP network to said network-gateway device and said IP terminal device that includes a function to transmit and receive IP packets, said IP terminal device comprising:
a memory storing an authentication code; and
an IP-terminal-location-registration-request unit transmitting an IP-terminal-location-registration-request message including the authentication code therein to said network-gatekeeper device.
